(19) United States
(12) Patent Application Publication
(10) Pub. No.: US 2024/0089880 A1
(43) Pub. Date: Mar. 14, 2024

(54) USER EQUIPMENT UPLINK SYNCHRONIZATION

(71) Applicant: Apple Inc., Cupertino, CA (US)

(72) Inventors: Fangli Xu, Beijing (CN); Haijing Hu, Los Gatos, CA (US); Ping-Heng Kuo, London (GB); Ralf Rossbach, Munich (DE)

(73) Assignee: Apple Inc., Cupertino, CA (US)

(21) Appl. No.: 18/463,151

(22) Filed: Sep. 7, 2023

Related U.S. Application Data
(60) Provisional application No. 63/405,397, filed on Sep. 10, 2022.

(51) Int. Cl. H04W 56/00; H04W 74/08

(52) U.S. Cl. CPC H04W 56/001; H04W 74/0833

(57) ABSTRACT

The present application relates to devices and components including apparatus, systems, and methods to provide uplink synchronization for a user equipment with one or more uplink transmissions to be transmitted.

### CROSS-REFERENCE TO RELATED APPLICATIONS

This application claims priority to U.S. provisional application No. 63/405,397, entitled “User Equipment Uplink Synchronization,” filed on Sep. 10, 2022, the disclosure of which is incorporated by reference herein in its entirety for all purposes.

### TECHNICAL FIELD

The present application relates to the field of wireless technologies and, in particular, to user equipment uplink synchronization.

### BACKGROUND

Third Generation Partnership Project (3GPP) networks provide for communication between user equipments (UEs) and base stations. To facilitate communication, at least a portion of the transmissions between the UEs and the base stations require that the UE and the base station exchanging the transmission be synchronized. One or more transmissions may be prevented or may fail if attempted to be transmitted while the UE and the base station are out of synchronization.

### BRIEF DESCRIPTION OF THE DRAWINGS

FIG. 1 illustrates an example signaling chart showing an uplink (UL) grant operation in accordance with some embodiments.

FIG. 2 illustrates an example signaling chart showing a hybrid automatic repeat request (HARQ) procedure in accordance with some embodiments.

FIG. 3 illustrates an example signaling chart showing a UL-sync request while a user equipment (UE) is in a UL out-of-sync state in accordance with some embodiments.

FIG. 4 illustrates an example signaling chart showing a UL-sync request being transmitted as a UL out-of-sync state is approaching in accordance with some embodiments.

FIG. 5 illustrates an example signaling chart related option 1 for the UL synchronization (UL-sync) request in accordance with some embodiments.

FIG. 6 illustrates an example signaling chart related to option 2 for the UL-sync request in accordance with some embodiments.

FIG. 7 illustrates an example signaling chart related option 3 for the UL-sync request in accordance with some embodiments.

FIG. 8 illustrates an example signaling chart with timing alignment timer (TAT) restart upon UL transmission to complete a HARQ procedure in accordance with some embodiments.

FIG. 9 illustrates an example signaling chart with TAT restart upon expiry of the TAT timer in accordance with some embodiments.

FIG. 10 illustrates an example signaling chart with UL transmission without a TAT being restarted in accordance with some embodiments.

FIG. 11 illustrates an example timer arrangement for determining when a UL out-of-sync state is approaching in accordance with some embodiments.

FIG. 12 illustrates another example timer arrangement for determining when a UL out-of-sync state is approaching in accordance with some embodiments.

FIG. 13 illustrates an example signaling chart with UL-sync request signaling via layer 1 (L1), layer 2 (L2), or layer 3 (L3) signaling in accordance with some embodiments.

FIG. 14 illustrates an example signaling chart with UL-sync request signaling with multi-timing advance group (TAG) configuration in accordance with some embodiments.

FIG. 15 illustrates an example signaling chart for random access channel (RACH) procedure UL-sync request in accordance with some embodiments.

FIG. 16 illustrates an example procedure of operating a UE in accordance with some embodiments.

FIG. 17 illustrates an example procedure of operating a UE in accordance with some embodiments.

FIG. 18 illustrates an example procedure of operating a base station in accordance with some embodiments.

FIG. 19 illustrates an example UE in accordance with some embodiments.

FIG. 20 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

Third Generation Partnership Project (3GPP) networks (such as cellular networks) can have user equipments (UEs) be in-synchronization (in-sync) or out-of-synchronization (out-of-sync) with base stations. In legacy approaches, the types of uplink (UL) transmissions that can be transmitted when a UE is out-of-sync with a target base station may be limited. The limited transmissions that can be transmitted when the UE is out-of-sync can cause issues, such as when the UL transmission to be transmitted when the UE is out-of-sync is in response to a corresponding downlink (DL) transmission. Approaches described herein may address at least some of the issues caused by the limited UL transmissions allowed while the UE is out-of-sync, among addressing other issues.

### Uplink Synchronization Maintenance Mechanism

The connected user equipment (UE) has two uplink (UL) synchronization (sync) states: 1) UL in-sync: UE is synchronized with network (NW) in uplink, and UL transmission on physical uplink control channel (PUCCH)/physical uplink shared channel (PUSCH)/sounding reference signal (SRS) is allowed; 2) UL out-of-sync: UE lost the uplink sync with NW, and cannot perform any uplink transmission except preamble, UE will ignore the received UL grant. For example, a UE that is connected to a base station may be in a UL in-sync state or a UL out-of-sync state.

While in the UL in-sync state, the UE may be synchronized with a base station to which the UE is connected for UL transmissions. For legacy approaches, the UE may be allowed to transmit non-preamble UL transmissions. The non-preamble UL transmissions may include any transmissions other than preamble transmissions. In some embodiments, the preamble transmissions may comprise physical random access channel (PRACH) UL transmissions and/or random access channel (RACH) transmissions. The non-preamble UL transmissions may include PUCCH transmissions, PUSCH transmissions, and SRS transmissions.

While in the UL out-of-sync state, the UE may be unsynchronized with a base station to which the UE is connected for UL transmissions. The UE may be in the out-of-sync state for UL transmissions based on the UE losing uplink synchronization with the base station. For legacy approaches, the UL transmissions that can be transmitted while the UE is in the UL out-of-sync state may be limited to preambles. Accordingly, UL transmissions other than preambles may be prevented from being transmitted by the UE while the UE is in the UL out-of-sync state for legacy approaches. The UE may ignore received UL grants that are received when the UE is in the out-of-sync state and/or when the UL transmissions corresponding to the UL grants are scheduled to be transmitted while the UE is in the out-of-sync state.

Uplink sync state maintenance is controlled by a timing alignment timer (TAT). TAT is started based on receiving the timing advance (TA) command from NW (for example, a timing advance command (TAC) medium access control (MAC) control element (CE)). Upon TAT expiry, UE will enter UL out-of-sync state, and release all dedicated uplink physical resource (for example, PUCCH, SRS). For example, a UE may maintain a TAT. Once started, the TAT will countdown from a value until the TAT expires, where the value may be defined by a configuration for the UE or provided in a TA command (such as a TAC MAC CE). The TAT will start counting down once the TA command has been processed. When the TAT expires, the UE may enter the UL out-of-sync state and may release all dedicated UL physical resources, such as PUCCH resources and/or SRS resources.

UE in UL out-of-sync state can re-enter in-sync state via the two methods: 1. Perform RACH procedure to acquire initial UL TA, and the RACH can be triggered in two ways: a) next generation NodeB (gNB) triggers the RACH via physical downlink control channel (PDCCH) order, b) UE triggers the RACH upon the uplink data arrival (for example, random access for scheduling request (RA-SR)); 2. Receive TAC MAC CE from NW. For example, a UE can re-enter a UL in-sync state through performing a RACH procedure or receiving a TAC MAC CE from a base station. In legacy approaches, the RACH procedure can either be triggered by a base station triggering the RACH procedure via a PDCCH order or a UE triggering the RACH procedure upon UL data arrival.

UL TA maintenance in carrier aggregation (CA). A UE with multiple timing advance capability for CA can simultaneously receive and/or transmit on multiple component carriers (CCs) corresponding to multiple serving cells with different timing advances (multiple serving cells grouped in multiple timing advance groups (TAGs)). Next generation radio access network (NG-RAN) ensures that each TAG contains at least one serving cell. For example, for UEs that have multiple timing advance capability for CA, the UE may receive and/or transmit on CCs corresponding to multiple service cells. Each of the services cells may be assigned to a TAG, where there may be one or more TAGs corresponding to the UE. Each of the TAGs corresponding to the UE may include at least one serving cell.

### Issue Statement

Within one TAG, if TAT expires within one hybrid automatic repeat request (HARQ) scheduling procedure, the HARQ procedure cannot be completed. For example, if a TAT maintained by a UE involved in a HARQ procedure expires, the HARQ procedure cannot be completed in legacy approaches. For DL HARQ scheduling, UE cannot provide the acknowledge/negative acknowledge (A/N) feedback to NW if the TAT expires in legacy approaches. For UL HARQ scheduling, UE cannot perform the UL transmission if the TAT expires in legacy approaches. Accordingly, the HARQ procedure cannot be completed based on the lack of A/N feedback and/or the lack of UL transmission in legacy approaches. NOTE: with the repetition transmission, the whole HARQ procedure takes longer in legacy approaches.

If UE TAT expiry occurs during the HARQ procedure, UE cannot trigger the RACH for UL sync according to current specification. For example, a UE cannot trigger a RACH procedure for UL synchronization in legacy approaches when TAT of a UE expires during a HARQ procedure involving the UE. gNB may not detect the reason of the HARQ failure, if the gNB does not track the UE UL TA frequently or the TAT maintenance between gNB and UE is not sync. For example, a base station may not determine a reason for a HARQ failure in legacy approaches if the base station does not track the UE UL TA frequently or the TAT maintenance between the base station and the UE is not synchronized.

The potential consequence if gNB misunderstands the UE has valid UL TA and in UL-in-sync state: The ongoing HARQ procedure can not be completed successfully, and UE's data transmission can not be recovered quickly; The NW scheduling is wasted, and the network resource efficiency is reduced. For example, a base station may misunderstand that the UE has valid UL TA and/or that the UE is in a UL in-sync state. For example, the base station may believe that the UE has a valid UL TA and/or that the UE is in a UL in-sync state while UE actually have an invalid UL TA and/or is in a UL out-of-sync state in some instances. In these instances, an ongoing HARQ procedure may not be completed and/or a data transmission of a UE may not be recovered quickly. Further in these instances, a NW scheduling provided by the base station may be wasted and/or the NW resource efficiency may be reduced.

To avoid the negative consequence, some enhancements may be introduced to help UE in UL in-sync state for the potential UL transmission. Case 1: When UE is in UL out-of-sync state has data for transmissions. Case 2: When UE is about to enter the UL out-of-sync state and UE has data for transmission to avoid the potential risk to enter the UL out-of-sync state during the UL transmission. For example, negative consequences may occur in legacy approaches where a UE is in a UL out-of-sync state and has data transmissions to be transmitted. Further, negative consequences may occur in legacy approaches where a UE is about to enter a UL out-of-sync state and has data for transmission. Approaches described throughout this disclosure may include enhancements that can address the negative consequences in these instances.

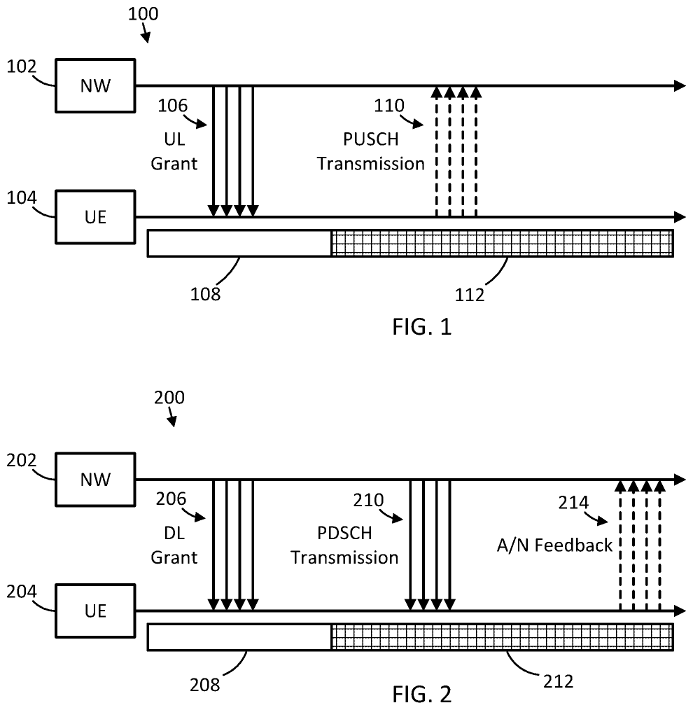

FIG. 1 illustrates an example signaling chart 100 showing a UL grant operation in accordance with some embodiments. In particular, the signaling chart 100 illustrates example signaling that may be exchanged between a base station and a UE as part of a UL grant operation. The UL grant operation may provide resources and/or scheduling for a UL transmission of the UE.

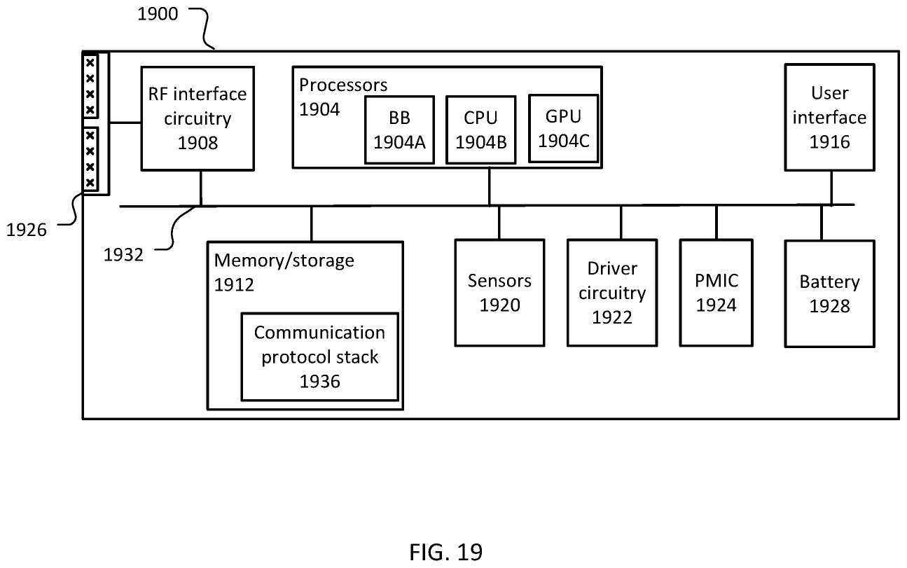

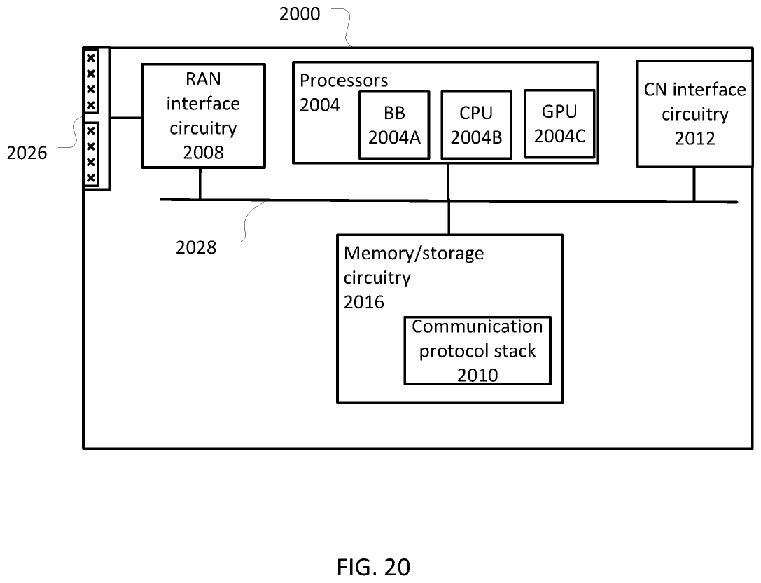

The signaling chart 100 may include a base station 102. The base station 102 may include one or more of the features of the gNB 2000 (FIG. 20). Further, the signaling chart 100 may include a UE 104. The UE 104 may include one or more of the features of the UE 1900 (FIG. 19). The UE 104 may be connected to the base station 102. For example, the base station 102 may operate a cell to which the UE 104 is connected.

In the illustrated embodiment, the base station 102 may transmit a plurality of UL grants 106 to the UE 104. The UL grants 106 may indicate a plurality of resources and/or scheduling for PUSCH transmissions to be transmitted by the UE 104. The UL grants 106 may be transmitted while the UE 104 is in a UL in-sync state 108 with the base station 102.

The UE 104 may identify the UL grants 106 received from the base station 102. Based on the UL grants 106, the UE 104 may determine resources and/or scheduling for a plurality of PUSCH transmission opportunities 110. The UE 104 may have transitioned from the UL in-sync state 108 to a UL out-of-sync state 112. For example, a TAT maintained by the UE 104 may have expired after receiving the UL grants 106 causing the UE 104 to transition to the UL out-of-sync state 112 with the base station 102. Due to the UE 104 being in the UL out-of-sync state 112 when the PUSCH transmission opportunities 110 are scheduled, the UE 104 may be unable to transmit PUSCH transmissions scheduled to be transmitted during the PUSCH transmission opportunities 110 (as indicated by the PUSCH transmission opportunities 110 being shown in dashed lines). Due to the UE 104 being unable to transmit the PUSCH transmissions, the scheduling may be wasted and/or the NW resource efficiency may be reduced.

FIG. 2 illustrates an example signaling chart 200 showing a HARQ procedure in accordance with some embodiments. In particular, the signaling chart 200 illustrates example signaling that may be exchanged between a base station and a UE as part of a HARQ procedure.

The signaling chart 200 may include a base station 202. The base station 202 may include one or more of the features of the gNB 2000 (FIG. 20). Further, the signaling chart 200 may include a UE 204. The UE 204 may include one or more of the features of the UE 1900 (FIG. 19). The UE 204 may be connected to the base station 202. For example, the base station 202 may operate a cell to which the UE 204 is connected.

In the illustrated embodiment, the base station 202 may transmit a plurality of DL grants 206 to the UE 204. The DL grants 206 may indicate a plurality of resources and/or scheduling for physical downlink shared channel (PDSCH) transmissions to be transmitted by the base station 202. The DL grants 206 may be transmitted while the UE 204 is in a UL in-sync state 208 with the base station 202.

The UE 204 may identify the DL grants 206 received from the base station 202. Based on the DL grants 206, the UE 204 may determine resources and/or scheduling for a plurality of PDSCH transmissions 210. The UE 204 may have transitioned from the UL in-sync state 208 to a UL out-of-sync state 212. For example, a TAT maintained by the UE 204 may have expired after receiving the DL grants 206 causing the UE 204 to transition to the UL out-of-sync state 212 with the base station 102. As the PDSCH transmissions 210 are DL transmissions, the base station 202 may still be capable of transmitting the PDSCH transmissions 210 and the UE 204 may still be capable of identifying the PDSCH transmissions 210 even though the UE 204 is in the UL out-of-sync state 212. In other instances, the UE 204 may transition to the UL out-of-sync state 212 after the PDSCH transmissions 210 have been transmitted.

The UE 204 may be configured to transmit HARQ feedback to the base station 202 as part of a HARQ procedure for the PDSCH transmissions 210. For example, the UE 204 may be configured to provide a plurality of A/N feedback transmissions to indicate whether each of the PDSCH transmissions were received or not received. A plurality of A/N feedback transmission opportunities 214 may be scheduled for the A/N feedback transmissions. Further, the base station 202 may be configured to monitor for the A/N feedback transmissions to determine whether the UE 204 properly receive and process the PDSCH transmissions 210. Due to the UE 204 being in the UL out-of-sync state 212 when the A/N feedback transmissions opportunities 214 are scheduled, the UE 204 may be unable to transmit the A/N feedback transmissions during the A/N feedback transmission opportunities 214 (as indicated by the A/N feedback transmission opportunities 214 being shown in dashed lines). Due to the A/N feedback transmissions not being transmitted, the HARQ procedure, of which the A/N feedback transmissions are a part, may not be completed successfully. As the base station 202 does not receive the A/N feedback transmissions, the base station 202 continue to wait for the A/N feedback transmissions and/or retransmit the PDSCH transmissions 210, which can result in signaling delays.

Approach: General Description

UL-sync request from UE to NW. UE can indicate NW the UL-sync request in the following two cases: Case 1: When UE needs to perform the UL transmission but UE is in UL out-of-sync state; Case 2: When UE needs to perform the UL transmission but UE is about to enter the UL out-of-sync state. For example, a UE may transmit an uplink synchronization (UL-sync) request to a base station to request information from the base station to be utilized for synchronizing the UL of the UE. The UE may transmit the UL-sync request when UE has one or more UL transmissions to be transmitted and the UE is in a UL out-of-sync state in some instances. In some instances, the UE may transmit the UL-sync request when the UE has one or more UL transmissions to be transmitted and the UE is about to enter the UL out-of-sync state.

About the UL-sync request, it can have two options: Option 1: UE informs about the request via the layer 1(L1)/layer 2 (L2)/layer 3 (L3) signaling; Option 2: UE triggers RACH for UL sync purpose. The feature can be under the NW control and based NW configuration. For example, the UE may transmit UL-sync request to base station via L1 signaling, L2 signaling, or L3 signaling in some instances. In some instances, the UL-sync request may trigger a RACH procedure to synchronize the UL of the UE.

Expected NW operation. Upon receiving the UL-sync request, gNB can trigger UE in UL in-sync state via sending TAC MAC CE or trigger RACH. For example, the base station may transmit a TAC MAC CE or trigger a RACH procedure upon receiving the UL-sync request from the UE. The TAC MAC CE or the RACH procedure may trigger the UE to transition to the in-sync state.

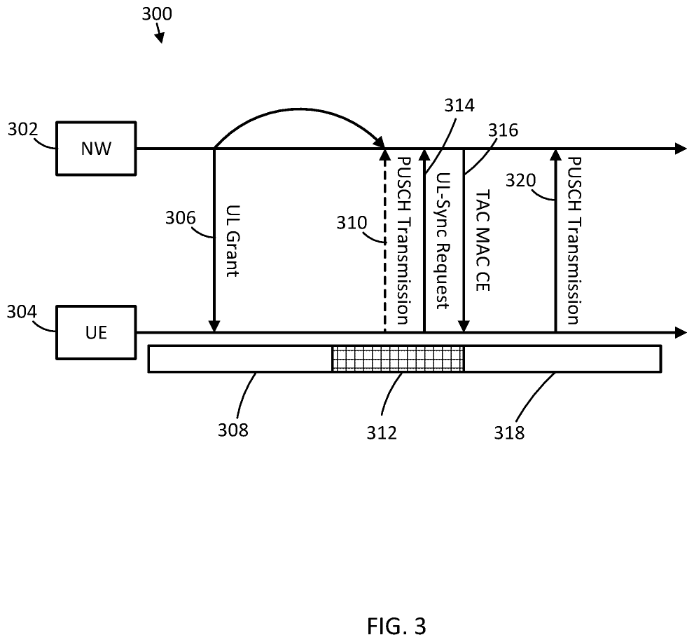

FIG. 3 illustrates an example signaling chart 300 showing a UL-sync request while a UE is in a UL out-of-sync state in accordance with some embodiments. In particular, the signaling chart 300 illustrates signaling that may be exchanged between a base station and a UE related to a UL grant. In the illustrated signaling chart 300, the UE may have one or more UL transmissions to be transmitted when the UE is in a UL out-of-sync state and may send a UL-sync request to synchronize the UL of the UE.

The signaling chart 300 may include a base station 302. The base station 302 may include one or more of the features of the gNB 2000 (FIG. 20). Further, the signaling chart 300 may include a UE 304. The UE 304 may include one or more of the features of the UE 1900 (FIG. 19). The UE 304 may be connected to the base station 302. For example, the base station 302 may operate a cell to which the UE 304 is connected.

In the illustrated embodiment, the base station 302 may transmit a UL grant 306 to the UE 304. The UL grant 306 may indicate one or more resources and/or scheduling for a PUSCH transmission to be transmitted by the UE 304. The UL grant 306 may be transmitted while the UE 304 is in a UL in-sync state 308 with the base station 302.

The UE 304 may identify the UL grant 306 received from the base station 302. Based on the UL grant 306, the UE 304 may determine one or more resources and/or scheduling for a corresponding PUSCH transmission opportunity 310. The UE 304 may have transitioned from the UL in-sync state 308 to a UL out-of-sync state 312. For example, a TAT maintained by the UE 304 may have expired after receiving the UL grant 306 causing the UE 304 to transition to the UL out-of-sync state 312 with the base station 302. Due to the UE 304 being in the UL out-of-sync state 312 when the PUSCH transmission opportunity 310 is scheduled, the UE 304 may be unable to transmit the PUSCH transmission (as indicated by the PUSCH transmission opportunity 310 being shown in dashed lines).

In the illustrated embodiment, the UE 304 may determine that a UL-sync request 314 is to be transmitted based on the UE 304 being in the UL out-of-sync state 312 and the UE 304 having the PUSCH transmission to be transmitted. Based on the determination, the UE 304 may transmit the UL-sync request 314 to the base station 302 while the UE 304 is in the UL out-of-sync state 312 with the base station 302. In some embodiments, the UE 304 may transmit the UL-sync request 314 via L1 signaling, L2 signaling, or L3 signaling. In some embodiments, the UE 304 may transmit the UL-sync request 314 to trigger a RACH procedure for synchronization of the UL of the UE 304. The UL-sync request 314 may indicate that the UE 304 is in the UL out-of-sync state 312 and/or may request information from the base station 302 to synchronize the UL of the UE 304.

The base station 302 may identify the UL-sync request 314 received from the UE 304. Based on the UL-sync request 314, the base station 302 may determine that the UE 304 is in the UL out-of-sync state 312 and/or that a TAC MAC CE 316 is to be transmitted to the UE 304. The TAC MAC CE 316 may provide information for synchronizing the UL of the UE 304. For example, the TAC MAC CE 316 may indicate that a TAT is to be restarted and/or a value for the TAT. The base station 302 may transmit the TAC MAC CE 316 in response to the UL-sync request 314. The TAC MAC CE 316 may trigger the UE 304 to transition to a UL in-sync state. In some embodiments, the base station 302 may trigger a RACH procedure to cause the UE 304 to transition to the UL in-sync state.

The UE 304 may identify the TAC MAC CE 316 received from the base station 302. The UE 304 may identify the value for the TAT and/or the indication that the TAT is to be restarted included in the TAC MAC CE 316. The UE 304 may restart the TAT based on the value and/or the indication. For example, the UE 304 may set the value of the TAT to the value from the TAC MAC CE 316 in some embodiments. In other embodiments, the UE 304 may set the value of the TAT to a pre-configured value. The UE 304 may initiate countdown of the TAT upon processing of the TAC MAC CE 316. The UE 304 may transition to a UL in-sync state 318 based on the countdown of the TAT being initiated. Once the UE 304 has transitioned to the UL in-sync state 318, the UE 304 may transmit the PUSCH transmission 320 that was scheduled to be transmitted in the PUSCH transmission opportunity 310. Accordingly, the UE 304 may transmit the PUSCH transmission 320 sooner than if the UE 304 had to wait for synchronization to be initiated by the base station 302 and/or the UL grant 306 may not be wasted.

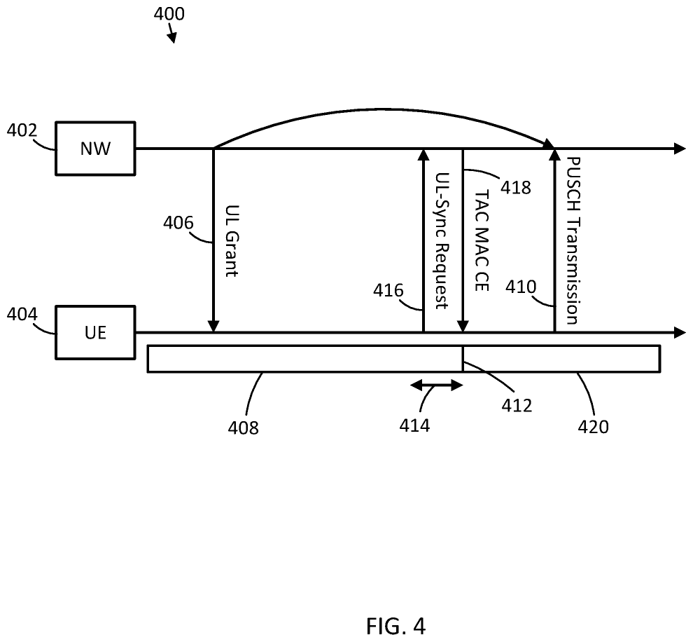

FIG. 4 illustrates an example signaling chart 400 showing a UL-sync request being transmitted as a UL out-of-sync state is approaching in accordance with some embodiments. In particular, the signaling chart 400 illustrates signaling that may be exchanged between a base station and a UE related to a UL grant. In the illustrated signaling chart 400, the UE may have one or more UL transmissions to be transmitted as the UE is approaching a UL out-of-sync state and may send a UL-sync request to synchronize the UL of the UE as the UE is approaching the UL out-of-sync state.

The signaling chart 400 may include a base station 402. The base station 402 may include one or more of the features of the gNB 2000 (FIG. 20). Further, the signaling chart 400 may include a UE 404. The UE 404 may include one or more of the features of the UE 1900 (FIG. 19). The UE 404 may be connected to the base station 402. For example, the base station 402 may operate a cell to which the UE 404 is connected.

In the illustrated embodiment, the base station 402 may transmit a UL grant 406 to the UE 404. The UL grant 406 may indicate one or more resources and/or scheduling for a PUSCH transmission to be transmitted by the UE 404. The UL grant 406 may be transmitted while the UE 404 is in a UL in-sync state 408 with the base station 402.

The UE 404 may identify the UL grant 406 received from the base station 402. Based on the UL grant 406, the UE 404 may determine one or more resources and/or scheduling for a corresponding PUSCH transmission 410. The UE 404 may determine a time 412 at which a TAT is set to expire. While waiting for transmission of the PUSCH transmission 410, the UE 404 may determine that the time 412 at which the TAT is set to expire is approaching. For example, the UE 404 may be configured with a window 414 prior to the time 412. The window 414 may extend from the time 412 for a certain period of time prior to the time 412 at which the TAT is set to expire. The UE 404 may determine that the UE 404 is about to enter a UL out-of-sync state based on the beginning of the window 414.

The UE 404 may determine that a UL-sync request is to be transmitted to synchronize the UL of the UE 404 based on the determination that the UE 404 is about to enter the UL out-of-sync state and the scheduled PUSCH transmission 410 not being transmitted. Based on the determination, the UE 404 may transmit a UL-sync request 416 to the base station 402. In some embodiments, the UE 404 may transmit the UL-sync request 416 via L1 signaling, L2 signaling, or L3 signaling. In some embodiments, the UE 404 may transmit the UL-sync request 416 to trigger a RACH procedure for synchronization of the UL of the UE 404. The UL-sync request 416 may indicate that the UE 304 is about to enter the UL out-of-sync state and/or may request information from the base station 402 to synchronize the UL of the UE 404.

The base station 402 may identify the UL-sync request 416 received from the UE 404. Based on the UL-sync request 416, the base station 402 may determine that the UE 404 is approaching the UL out-of-sync state and/or that a TAC MAC CE 418 is to be transmitted to the UE 404. The TAC MAC CE 418 may provide information for synchronizing the UL of the UE 404. For example, the TAC MAC CE 418 may indicate that a TAT is to be restarted and/or a value for the TAT. The base station 402 may transmit the TAC MAC CE 418 in response to the UL-sync request 416. The TAC MAC CE 418 may trigger the UE 404 to continue to a UL in-sync state 420. In some embodiments, the base station 402 may trigger a RACH procedure to cause the UE 404 to continue to the UL in-sync state 420.

The UE 404 may identify the TAC MAC CE 418 received from the base station 402. The UE 404 may identify the value for the TAT and/or the indication that the TAT is to be restarted included in the TAC MAC CE 418. The UE 404 may restart the TAT based on the value and/or the indication. For example, the UE 404 may set the value of the TAT to the value from the TAC MAC CE 418 in some embodiments. In other embodiments, the UE 404 may set the value of the TAT to a pre-configured value. The UE 304 may initiate countdown of the TAT upon processing of the TAC MAC CE 418. The UE 404 may continue to the UL in-sync state 420 based on the countdown of the TAT being initiated. Since the UE 404 is in the UL in-sync state 420 at the scheduled time for the PUSCH transmission 410, the UE 404 may transmit the PUSCH transmission 410 to the base station 402. Accordingly, the UE 404 may transmit the PUSCH transmission 410 without delay that may be caused by the UL of the UE being out-of-sync and/or the UL grant 406 may not be wasted.

### Case 1: When UE is in UL Out-of-Sync State

For case 1 to trigger the UL-sync request, UE in UL out-of-sync state can trigger the UL-sync request in one or more conditions as follows. Option 1: UE needs to perform the A/N feedback to the received DL PDSCH transmission or for channel state information (CSI) report transmission. For example, the UE may transmit a UL-sync request to a base station that the UE is connected to when the UE has A/N feedback to transmit based on a DL PDSCH transmission received from the base station or when the UE has a CSI report transmission to transmit to the base station. The UE may be out-of-sync when the A/N feedback or the CSI report is to be transmitted.

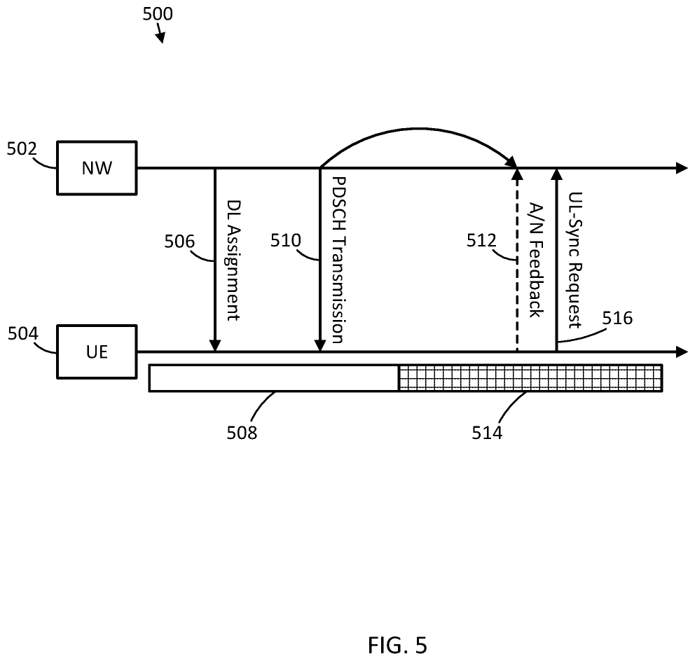

FIG. 5 illustrates an example signaling chart 500 related option 1 for the UL-sync request in accordance with some embodiments. In particular, the signaling chart 500 illustrates signals that may be exchanged between a base station and a UE for A/N feedback to be transmitted while the UE is in a UL out-of-sync state with the base station. A UL-sync request may be transmitted based on the A/N feedback to be transmitted while the UE is in a UL out-of-sync state.

The signaling chart 500 may include a base station 502. The base station 502 may include one or more of the features of the gNB 2000 (FIG. 20). Further, the signaling chart 500 may include a UE 504. The UE 504 may include one or more of the features of the UE 1900 (FIG. 19). The UE 504 may be connected to the base station 502. For example, the base station 502 may operate a cell to which the UE 504 is connected.

In the illustrated embodiment, the base station 502 may transmit a DL assignment 506 to the UE 504. The DL assignment 506 may indicate one or more resources and/or scheduling for a PDSCH transmission to be transmitted by the base station 502. The DL assignment 506 may be transmitted while the UE 504 is in a UL in-sync state 508 with the base station 502. The UE 504 may identify the DL assignment 506 and may determine that a PDSCH transmission is to be transmitted by the base station 502.

The base station 502 may transmit a PDSCH transmission 510 to the UE 504. The PDSCH transmission 510 may be transmitted based on the DL assignment 506. For example, the base station 502 may transmit the PDSCH transmission 510 using the one or more resources and/or the scheduling indicated by the DL assignment 506. The base station 502 may transmit the PDSCH transmission 510 while the UE 504 is still in the UL in-sync state 508 in the illustrated embodiment.

The UE 504 may identify the PDSCH transmission 510 received from the base station 502. The UE 504 may be configured to provide A/N feedback for the PDSCH transmission 510. Accordingly, the UE 504 may have an A/N feedback opportunity 512 scheduled for transmitting A/N feedback corresponding to the PDSCH transmission 510. The UE 504 may have transitioned from the UL in-sync state 508 to a UL out-of-sync state 514. For example, a TAT maintained by the UE 504 may have expired after receiving the PDSCH transmission 510 causing the UE 504 to transition to the UL out-of-sync state 514 with the base station 502. Due to the UE 504 being in the UL out-of-sync state 514 when the A/N feedback opportunity 512 is scheduled, the UE 504 may be unable to transmit the A/N feedback (as indicated by the A/N feedback opportunity 512 being shown in dashed lines).

In the illustrated embodiment, the UE 504 may determine that a UL-sync request 516 is to be transmitted based on the UE 504 being in the UL out-of-sync state 514 and the UE 504 having the A/N feedback to be transmitted. Based on the determination, the UE 504 may transmit the UL-sync request 516 to the base station 502 while the UE 504 is in the UL out-of-sync state 514 with the base station 502. In some embodiments, the UE 504 may transmit the UL-sync request 516 via L1 signaling, L2 signaling, or L3 signaling. In some embodiments, the UE 504 may transmit the UL-sync request 516 to trigger a RACH procedure for synchronization of the UL of the UE 504. The UL-sync request 516 may indicate that the UE 504 is in the UL out-of-sync state 514 and/or may request information from the base station 502 to synchronize the UL of the UE 504.

The base station 502 may identify the UL-sync request 516 received from the UE 504. Based on the UL-sync request 516, the base station 502 may determine that the UE 504 is in the UL out-of-sync state 514 and/or that a TAC MAC CE is to be transmitted to the UE 504.

Option 2: UE receives the UL grant. For example, the UE may transmit a UL-sync request to a base station that the UE is connected to when the UE receives a UL grant while the UE is in a UL out-of-sync state. The UE may transmit a UL-sync request based on the UE receiving the UL grant while the UE is in the UL out-of-sync state.

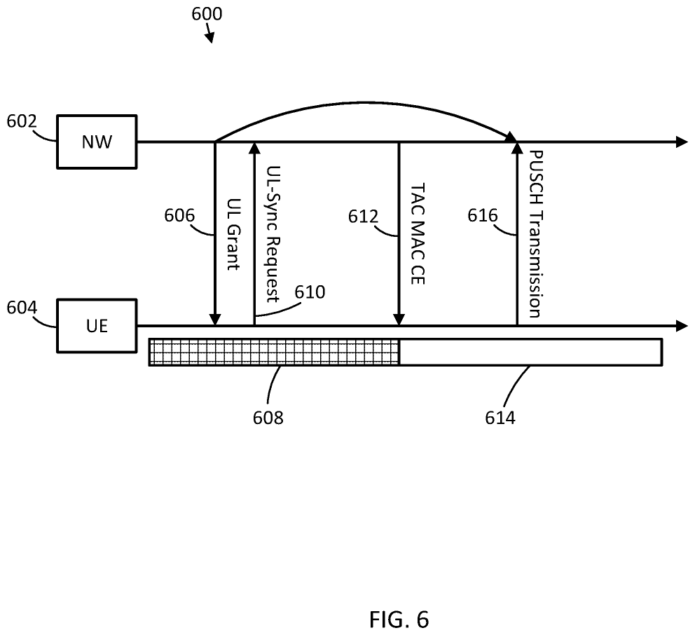

FIG. 6 illustrates an example signaling chart 600 related to option 2 for the UL-sync request in accordance with some embodiments. In particular, the signaling chart 600 illustrates signals that may be exchanged between a base station and a UE when a UL grant is received while the UE is in a UL out-of-sync state with the base station. A UL-sync request may be transmitted based on receipt of the UL grant while the UE is in a UL out-of-sync state.

The signaling chart 600 may include a base station 602. The base station 602 may include one or more of the features of the gNB 2000 (FIG. 20). Further, the signaling chart 600 may include a UE 604. The UE 604 may include one or more of the features of the UE 1900 (FIG. 19). The UE 604 may be connected to the base station 602. For example, the base station 602 may operate a cell to which the UE 604 is connected.

In the illustrated embodiment, the base station 602 may transmit a UL grant 606 to the UE 604. The UL grant 606 may indicate one or more resources and/or scheduling for a PUSCH transmission to be transmitted by the UE 604. The UL grant 606 may be transmitted while the UE 604 is in a UL out-of-sync state 608 with the base station 602.

The UE 604 may identify the UL grant 606 and may determine one or more resources and/or scheduling for a PUSCH transmission to be transmitted by the UE 604. The UE 604 may determine that a UL-sync request 610 is to be transmitted based on the UE 604 being in the UL out-of-sync state 608 and the UE identifying the UL grant 606. Based on the determination, the UE may transmit the UL-sync request 610 to the base station 602 while the UE 604 is in the UL out-of-sync state 608 with the base station 602. In some embodiments, the UE 604 may transmit the UL-sync request 610 via L1 signaling, L2 signaling, or L3 signaling. In some embodiments, the UE 604 may transmit the UL-sync request 610 to trigger a RACH procedure for synchronization of the UL of the UE 604. The UL-sync request 610 may indicate that the UE 604 is in the UL out-of-sync state and/or may request information from the base station 602 to synchronize the UL of the UE 604.

The base station 602 may identify the UL-sync request 610 received from the UE 604. Based on the UL-sync request 610, the base station 602 may determine that the UE 604 is approaching the UL out-of-sync state and/or that a TAC MAC CE 612 is to be transmitted to the UE 604. The TAC MAC CE 612 may provide information for synchronizing the UL of the UE 604. For example, the TAC MAC CE 612 may indicate that a TAT is to be restarted and/or a value for the TAT. The base station 602 may transmit the TAC MAC CE 612 in response to the UL-sync request 610. The TAC MAC CE 612 may trigger the UE 604 to continue to a UL in-sync state 614. In some embodiments, the base station 602 may trigger a RACH procedure to cause the UE 604 to continue to the UL in-sync state 614.

Once the UE 604 is in the UL in-sync state 614, the UE 604 may transmit a PUSCH transmission 616 to the base station 602. For example, the UE 604 may utilize the resources and/or the scheduling indicated by the UL grant 606 to transmit the PUSCH transmission 616. The UE 604 may transmit the PUSCH transmission 616 to the base station 602 while the UE 604 is in the UL in-sync state 614.

Option 3: UE needs to perform the PUSCH transmission according to the received UL grant. NOTE: The assumption is that UE is in UL in-sync state when receiving the UL grant but switches to the UL out-of-sync state before the actual PUSCH transmission is performed. For example, the UE may receive a UL grant while the UE is in a UL in-sync state. The UE may transition to a UL out-of-sync state after receiving the UL grant, such as due to a TAT of the UE expiring after receipt of the UL grant. The UE may be in the UL out-of-sync state for the one or more resources and/or scheduling for transmission of the PUSCH transmission. The UE may transmit a UL-sync request based on the UE being in the UL out-of-sync state for the resources and/or scheduling for transmission of the PUSCH transmission.

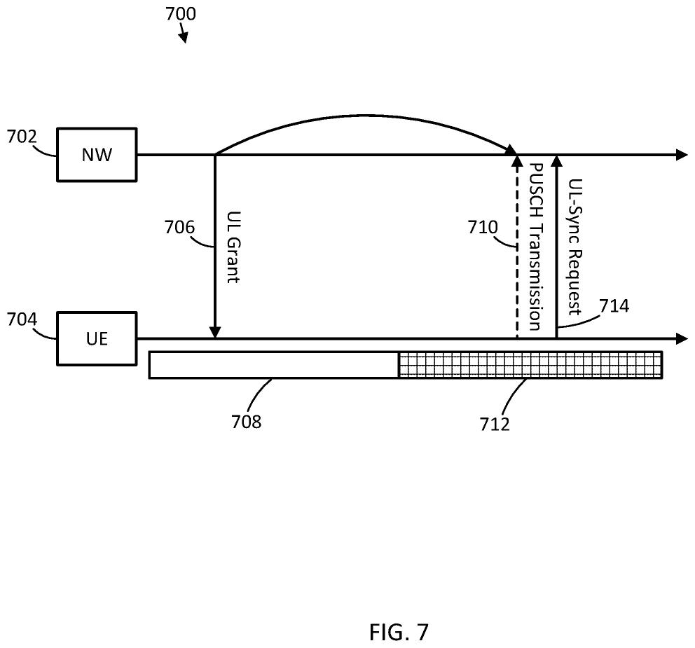

FIG. 7 illustrates an example signaling chart 700 related option 3 for the UL-sync request in accordance with some embodiments. In particular, the signaling chart 700 illustrates signals that may be exchanged between a base station and a UE for a PUSCH transmission to be transmitted while the UE is in a UL out-of-sync state with the base station. A UL-sync request may be transmitted based on the PUSCH transmission to be transmitted while the UE is in a UL out-of-sync state.

The signaling chart 700 may include a base station 702. The base station 702 may include one or more of the features of the gNB 2000 (FIG. 20). Further, the signaling chart 700 may include a UE 704. The UE 704 may include one or more of the features of the UE 1900 (FIG. 19). The UE 704 may be connected to the base station 702. For example, the base station 702 may operate a cell to which the UE 704 is connected.

In the illustrated embodiment, the base station 702 may transmit a UL grant 706 to the UE 704. The UL grant 706 may indicate one or more resources and/or scheduling for a PUSCH transmission to be transmitted by the UE 704. The UL grant 706 may be transmitted while the UE is in a UL in-sync state 708 with the base station 702.

The UE 704 may identify the UL grant 706 received from the base station 702. The UE 704 may determine the resources and/or scheduling for a PUSCH transmission opportunity 710 corresponding to the UL grant 706. The UE 704 may have transitioned from the UL in-sync state 708 to a UL out-of-sync state 712. For example, a TAT maintained by the UE 704 may have expired after receiving the UL grant 706 causing the UE to the UL out-of-sync state 712 with the base station 702. Due to the UE 704 being in the UL out-of-sync state 712 when the PUSCH transmission opportunity 710 is scheduled, the UE 704 may be unable to transmit the PUSCH transmission (as indicated by the PUSCH transmission opportunity 710 being shown in dashed lines).

In the illustrated embodiment, the UE 704 may determine that a UL-sync request 714 is to be transmitted based on the UE 704 being in the UL out-of-sync state 712 and the UE 704 having a PUSCH transmission to be transmitted. Based on the determination, the UE 704 may transmit the UL-sync request 714 to the base station 702 while the UE 704 is in the UL out-of-sync state 712 with the base station 702. In some embodiments, the UE 704 may transmit the UL-sync request 714 via L1 signaling, L2 signaling, or L3 signaling. In some embodiments, the UE 704 may transmit the UL-sync request 714 to trigger a RACH procedure for synchronization of the UL of the UE 704. The UL-sync request 714 may indicate that the UE 704 is in the UL out-of-sync state 712 and/or may request information from the base station 702 to synchronize the UL of the UE 704.

The base station 702 may identify the UL-sync request 714 received from the UE 704. Based on the UL-sync request 714, the base station 702 may determine that the UE 704 is in the UL out-of-sync state 712 and/or that a TAC MAC CE is to be transmitted to the UE 704.

### Case 1a: When UE is in UL Out-of-Sync State

Similar as the case 1, when the UE switches to the UL out-of-sync state during one scheduling procedure, for example, UE is in UL in-sync state when receiving the UL grant or PDSCH data, but switches to UL out-sync state before performing the UL transmission. UE can extend the TAT autonomously to complete this HARQ scheduling.

Option 1: Restart the TATimer upon the UL transmission. For example, a HARQ procedure may include one or more DL transmissions and one or more UL transmissions transmitted in response to the DL transmissions. For example, a PDSCH transmission may be transmitted from a base station to a UE and A/N feedback may be transmitted in response to the PDSCH transmission in some HARQ procedure embodiments. The UE may be in a UL in-sync state for the one or more DL transmissions of the HARQ procedure, but may transition to a UL out-of-sync state for the one or more UL transmissions of the HARQ procedure. The UE may extend the TAT autonomously, thereby transitioning to the UL in-sync state, for the one or more UL transmissions of the HARQ procedure to complete the HARQ procedure.

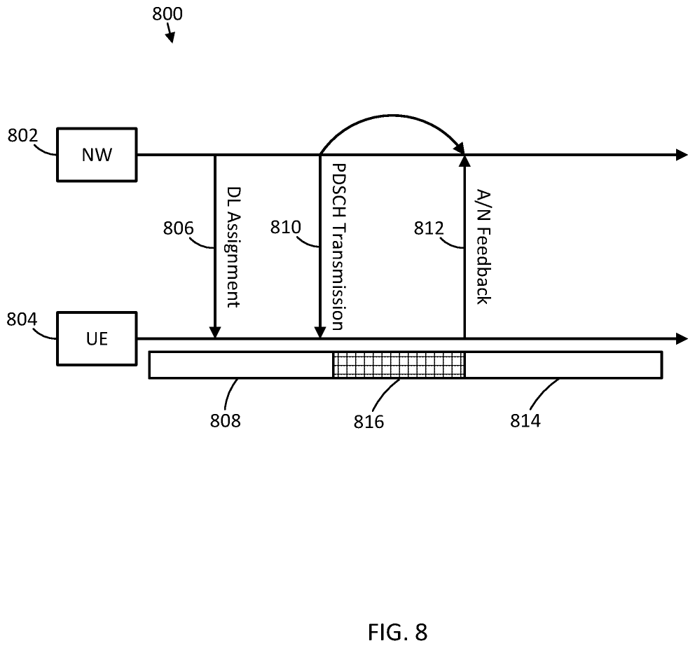

FIG. 8 illustrates an example signaling chart 800 with TAT restart upon UL transmission to complete a HARQ procedure in accordance with some embodiments. In particular, the signaling chart 800 illustrates signals that may be exchanged between a base station and a UE for TAT restart upon UL transmission to complete a HARQ procedure.

The signaling chart 800 may include a base station 802. The base station 802 may include one or more of the features of the gNB 2000 (FIG. 20). Further, the signaling chart 800 may include a UE 804. The UE 804 may include one or more of the features of the UE 1900 (FIG. 19). The UE 804 may be connected to the base station 802. For example, the base station 802 may operate a cell to which the UE 804 is connected.

In the illustrated embodiment, the base station 802 may transmit a DL assignment 806 to the UE 804. The DL assignment 806 may indicate one or more resources and/or scheduling for a PDSCH transmission to be transmitted by the base station 802. The DL assignment 806 may be transmitted while the UE 804 is in a UL in-sync state 808 with the base station 802. The UE 804 may identify the DL assignment 806 and may determine that a PDSCH transmission is to be transmitted by the base station 802.

The base station 802 may transmit a PDSCH transmission 810 to the UE 804. The PDSCH transmission 810 may be transmitted based on the DL assignment 806. For example, the base station 802 may transmit the PDSCH transmission 810 using the one or more resources and/or the scheduling indicated by the DL assignment 806. The base station 802 may transmit the PDSCH transmission 810 while the UE 804 is still in the UL in-sync state 808 in the illustrated embodiment.

The UE 804 may identify the PDSCH transmission 810 received from the base station 802. The UE 804 may be configured to provide A/N feedback 812 for the PDSCH transmission 810 as part of a HARQ procedure including the PDSCH transmission 810 and the A/N feedback 812. The UE 804 may have transitioned from the UL in-sync state 808 to a UL out-of-sync state 816 after the PDSCH transmission 810. For example, a TAT maintained by the UE 804 may have expired after receiving the PDSCH transmission 810 causing the UE 804 to transition to the UL out-of-sync state 816 with the base station 802.

The UE 804 may determine that the UE 804 will be in the UL out-of-sync state 816 when the A/N feedback 812 is to be transmitted. However, the UE 804 may be configured to restart the TAT maintained by the UE 804 upon UL transmission that is part of a HARQ procedure, which can cause the UE 804 to transition to a UL in-sync state 814. The UE 804 may determine that the A/N feedback 812 is part of a HARQ procedure with the PDSCH transmission 810 received by the UE 804. Accordingly, the UE 804 may determine that the TAT is to be restarted upon transmission of the A/N feedback 812. Therefore, the UE 804 may transmit the A/N feedback 812 and restart the TAT upon transmission of the A/N feedback 812, which causes the UE 804 to transition to the UL in-sync state 814. The UE 804 may be in the UL in-sync state 814 for the transmission of the A/N feedback 812 based on the TAT being restarted upon transmission of the A/N feedback 812.

Option 2: Restart the TATimer upon its expiry when UE have the potential scheduled UL transmission. For example, a HARQ procedure may include one or more UL grants and one or more UL transmissions corresponding to the UL grants. A UL grant may be transmitted from a base station to a UE and a PUSCH transmission may be transmitted based on the UL grant in some HARQ procedure embodiments. The UL may be in a UL in-sync state for the one or more UL grants, but may have a TAT that will expire prior to the one or more UL transmissions. The UE may extend the TAT autonomously, thereby transitioning to the UL in-sync state, for the one or more UL transmissions of the HARQ procedure to complete the HARQ procedure.

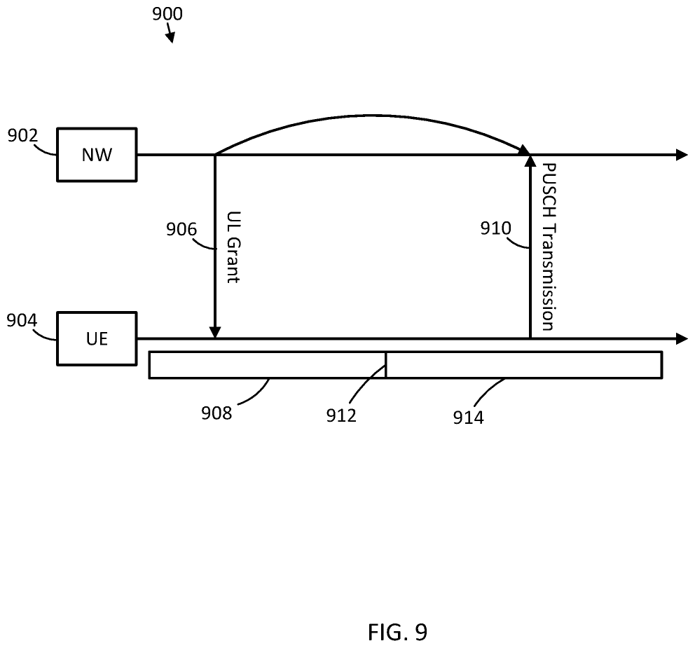

FIG. 9 illustrates an example signaling chart 900 with TAT restart upon expiry of the TAT timer in accordance with some embodiments. In particular, the signaling chart 900 illustrates signals that may be exchanged between a base station and a UE for a TAT restart upon TAT expiration when a UL transmission is scheduled as part of a HARQ procedure.

The signaling chart 900 may include a base station 902. The base station 902 may include one or more of the features of the gNB 2000 (FIG. 20). Further, the signaling chart 900 may include a UE 904. The UE 904 may include one or more of the features of the UE 1900 (FIG. 19). The UE 904 may be connected to the base station 902. For example, the base station 902 may operate a cell to which the UE 904 is connected.

In the illustrated embodiment, the base station 902 may transmit a UL grant 906 to the UE 904. The UL grant 906 may indicate one or more resources and/or scheduling for a PUSCH transmission to be transmitted by the UE 904. The UL grant 906 may be transmitted while the UE 904 is in a UL in-sync state 908 with the base station 902. The UE 904 may identify the UL grant 906 and may determine that a PUSCH transmission 910 is to be transmitted by the UE 904.

The UE 904 may determine the resources and scheduling for the PUSCH transmission 910. Further, the UE 904 may determine a time 912 that a TAT maintained by the UE 904 is set to expire, which would result in the UE 904 transitioning to a UL out-of-sync state. The UE 904 may determine that the PUSCH transmission 910 is to be transmitted after the TAT is to set to expire. Based on the determination that the PUSCH transmission 910 is to be transmitted after the TAT is set to expire, the UE 904 may determine that the TAT is to be restarted upon the expiration of the TAT. Accordingly, the UE 904 may restart the TAT upon the expiration of the TAT at the time 912, which would cause the UE 904 to transition from the UL in-sync state 908 to a UL in-sync state 914. The UE 904 may then transmit the PUSCH transmission 910 to the base station 902 while the UE is in the UL in-sync state 914.

Option 3: Not restart the TATimer but allow UE to complete the HARQ procedure, for example, complete the PUSCH transmission or A/N feedback. For example, a base station may transmit a DL transmission to a UE that is to schedule a UL transmission (such as a PUSCH transmission or A/N feedback) as part of a HARQ procedure. The UE may still transmit the UL transmission after the TAT has expired and the UE has transmitted to a UL out-of-sync state.

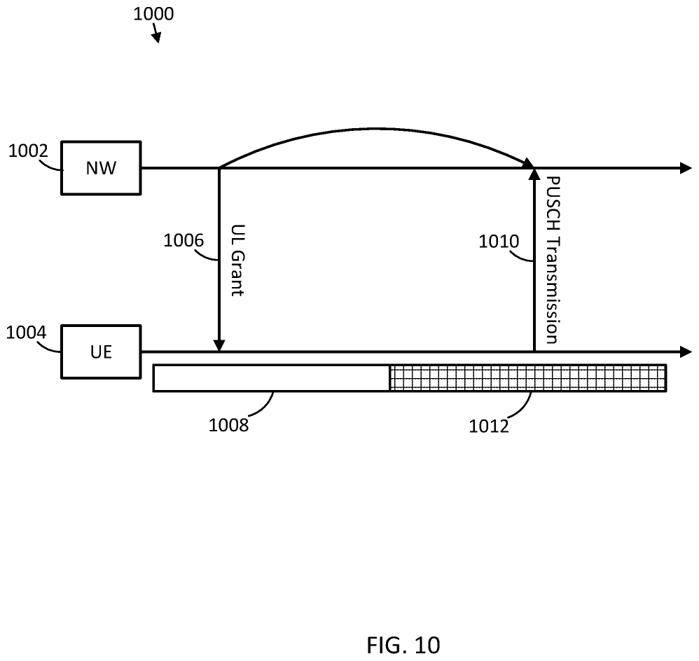

FIG. 10 illustrates an example signaling chart 1000 with UL transmission without a TAT being restarted in accordance with some embodiments. In particular, the signaling chart 1000 illustrates signals that may be exchanged between a base station and a UE for transmission of a UL transmission without restarting a TAT to complete a HARQ procedure.

The signaling chart 1000 may include a base station 1002. The base station 1002 may include one or more of the features of the gNB 2000 (FIG. 20). Further, the signaling chart 1000 may include a UE 1004. The UE 1004 may include one or more of the features of the UE 1900 (FIG. 19). The UE 1004 may be connected to the base station 1002. For example, the base station 1002 may operate a cell to which the UE 1004 is connected.

In the illustrated embodiment, the base station 1002 may transmit a UL grant 1006 to the UE 1004. The UL grant 1006 may indicate one or more resources and/or scheduling for a PUSCH transmission to be transmitted by the UE 1004. The UL grant 1006 may be transmitted while the UE 1004 is in a UL in-sync state 1008 with the base station 1002. The UE 1004 may identify the UL grant 1006 and may determine that a PUSCH transmission 1010 is to be transmitted by the UE 1004.

A TAT maintained by the UE 1004 may expire causing the UE 1004 to transition from the UL in-sync state 1008 to a UL out-of-sync state 1012. The UE 1004 may determine that the PUSCH transmission 1010 is to be transmitted after the TAT has expired and when the UE 1004 is in the UL out-of-sync state 1012. The UE 1004 may determine to transmit the PUSCH transmission 1010 to complete the HARQ procedure even though the TAT has expired and the UE 1004 is in the UL out-of-sync state 1012. The UE 1004 may transmit the PUSCH transmission 1010 to the base station 1002 without restarting the TAT. Accordingly, the PUSCH transmission 1010 is transmitted by the UE 1004 when the UE 1004 in in the UL out-of-sync state 1012 and does not transition back to a UL in-sync state for the transmission.

Case 2: When UE is about to Enter UL Out-of-Sync State

For case 2 to trigger the UL-sync request, UE can justify whether it's about to enter UL out-of-sync state based on the following methods. Option 1: Introduce a new timer (with the shorter value than TATimer). UE (re)starts the new timer when (re)starting the TATimer. When the new timer expires but the TATimer is running, UE can judge it is about to enter UL out-of-sync state. For example, the UE may be configured to start a timer at a same time that a TAT maintained by the UE is restarted. A time for the timer may be shorter than a time for the TAT. The countdown of the timer and the TAT both may be started at the time that the TAT is restarted. The timer may expire before the TAT expires. The UE may determine that the UE is about to enter the UL out-of-sync state based on the expiration of the timer. The UE determining that the UE is about to enter the out-of-sync state may trigger the UE to transmit a UL-sync request.

Option 2: Introduce a window. UE can judge it is about to enter the UL out-of-sync state when UE is in the window before the timepoint of the TATimer expiry. For example, the UE may be configured with a window utilized for determining when the UE is about to enter a UL out-of-sync state. The window may have a set period of time. The window may be configured with an end at a time that a TAT maintained by the UE is set to expire and may extend for the period of time prior to the expiry of the TAT. The UE may determine when the window starts and may determine that the UE is about to enter the UL out-of-sync state when the window starts. The UE determining that the UE is about to enter the out-of-sync state may trigger the UE to transmit a UL-sync request.

For both options, the timer/window configuration can be via the radio resource control (RRC) signaling or L2 MAC CE. For the MAC CE option, the configuration can be provided via a new MAC CE, or provided together with TAC in the updated TAC MAC CE. The configuration can be provided as the actual value or the index which refer to the actual value in RRC configuration. For example, the base station can provide RRC signaling or a L2 MAC CE to configure the UE with the timer or the window. The RRC signaling or L2 MAC CE may indicate a time or an index corresponding to time for the timer or the window.

When UE is about to enter UL out-of-sync state, UE can trigger the UL sync when UE has the UL data in the conditions which is same as that in case 1. For example, the UE may trigger a UL-sync request when the UE is to perform A/N feedback to a received DL PDSCH or for a CSI report transmission (corresponding to option 1 of case 1), the UE receives a UL grant (corresponding to option 2 of case 1), or the UE is to perform a PUSCH transmission according a received UL grant (corresponding to option 3 of case 1).

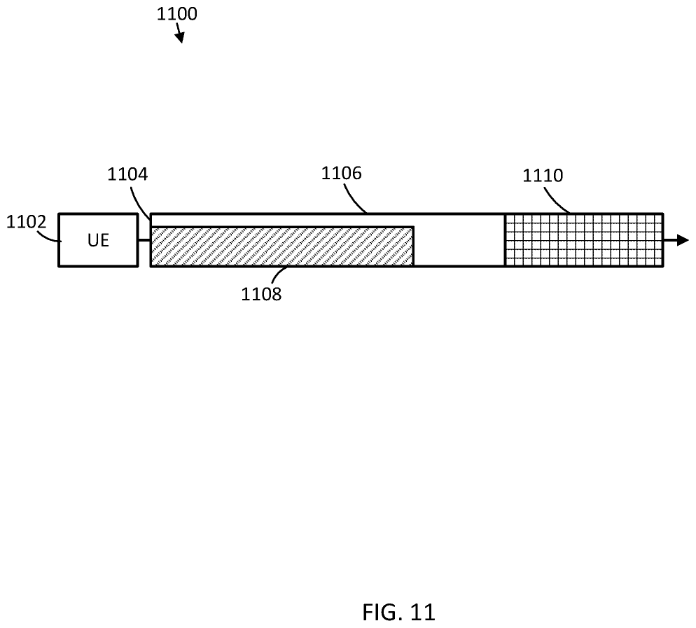

FIG. 11 illustrates an example timer arrangement 1100 for determining when a UL out-of-sync state is approaching in accordance with some embodiments. In particular, the timer arrangement 1100 illustrates a timer that a UE may utilize to determine when a UL out-of-sync state is approaching for triggering a UL-sync request.

The timer arrangement 1100 may include a UE 1102. The UE 1102 may include one or more of the features of the UE 1900 (FIG. 19). The timer arrangement 1100 may show a timer configuration for the UE 1102 and a UL sync state for the UE 1102.

A TAT maintained by the UE 1102 may be triggered at a time 1104. The TAT may extend for a period of time indicated by the UE 1102 being in a UL in-sync state 1106 in the illustrated embodiment. In particular, the UE 1102 may enter the UL in-sync state 1106 when the countdown of the TAT time is started and may exit UL in-sync state 1106 when the TAT time expires.

The UE 1102 may generate a timer 1108. The timer 1108 may be for a shorter time than the TAT as indicated by the timer 1108 being shorter than the UL in-sync state 1106. The UE 1102 may trigger the timer 1108 to start countdown at a same time the UE 1102 triggers the countdown of the TAT. Since the timer 1108 is shorter than the TAT and triggers countdown of the timer 1108 and the TAT at the same time, the timer 1108 may expire prior to the TAT. The UE 1102 may determine that the UE 1102 is about to transition from the UL in-sync state 1106 to a UL out-of-sync state 1110 based on the expiration of the timer 1108. The UE 1102 may determine to trigger a UL-sync request based on the determination that the UE is about to transition to the UL out-of-sync state 1110.

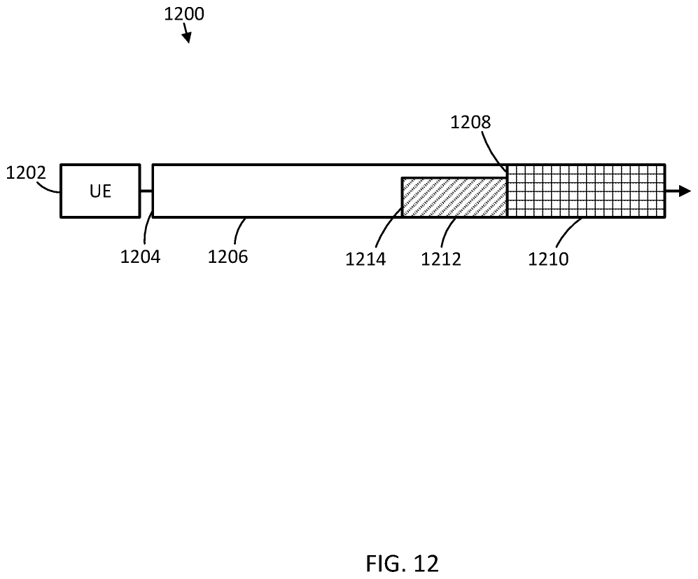

FIG. 12 illustrates another example timer arrangement 1200 for determining when a UL out-of-sync state is approaching in accordance with some embodiments. In particular, the timer arrangement 1200 illustrates a window that a UE may utilize to determine when a UL out-of-sync state is approaching for triggering a UL-sync request.

The timer arrangement 1200 may include a UE 1202. The UE 1202 may include one or more of the features of the UE 1900 (FIG. 19). The timer arrangement 1200 may show a timer configuration for the UE 1202 and a UL sync state for the UE 1202.

A TAT maintained by the UE 1202 may be triggered at a time 1204. The TAT may extend for a period of time indicated by the UE 1202 being in a UL in-sync state 1206 in the illustrated embodiment. In particular, the UE 1102 may enter the UL in-sync state 1206 when the countdown of the TAT time is started and may exit UL in-sync state 1206 when the TAT time expires. The UE 1202 may determine a time 1208 that the TAT expires. The time 1208 that the TAT expires may also be when the UE 1202 transitions from the UL in-sync state 1206 to a UL out-of-sync state 1210.

The UE 1202 may generate a window 1212. The window 1212 may have a set period of time, where the time of the window 1212 is shorter than a time of the TAT. The UE 1202 may set the window 1212 such that the window 1212 ends at a same time 1208 that the TAT is to expire and the UE 1202 is to transition to the UL out-of-sync state 1210. The window 1212 may extend for the set time prior to the time 1208. The UE 1202 may determine a time 1214 when the window 1212 begins. The UE 1202 may determine that the UL out-of-sync state 1210 is approaching at the time 1214 when the window 1212 begins. The UE 1202 may trigger a UL-sync request based on the determination that the UL out-of-sync state 1210 is approaching.

### Approach: UL-Sync Request Information

Option 1: UE informs about the request via the L1/L2/L3 signaling. For example, the UE may transmit a UL-sync request to a base station via L1, L2, or L3 signaling. The request indication is delivered via the UE dedicated UL grant or via the UE dedicated UL signal. For example, the UE may transmit the UL-sync request via a UE dedicated UL grant or via a UE dedicated UL signal. The request indication is transmitted when the UE is in UL in-sync state or in the UL in-sync TAG. For example, the UE may transmit the UL-sync request when the UE is in a UL in-sync state or in a UL in-sync TAG. In multi-TAG configuration, when one TAG is in UL out-of-sync state, UE can send the request via the other TAG where UE is still in in-sync state. For example, the UE may communicate with multiple TAGs in some instances. In instances where the UE is in a UL out-of-sync state with a first TAG and is in a UL in-sync state with a second TAG, the UE may transmit a UL-sync request via the second TAG that request synchronization for the first TAG.

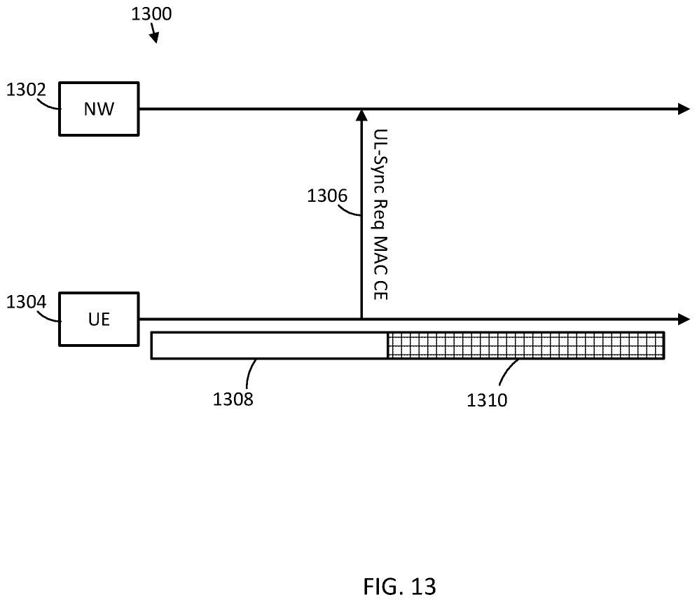

FIG. 13 illustrates an example signaling chart 1300 with UL-sync request signaling via L1, L2, or L3 signaling in accordance with some embodiments. For example, a UE may transmit a UL-sync request to a base station via L1, L2, or L3 signaling. The UE may transmit the UL-sync request while the UE is in a UL in-sync state.

The signaling chart 1300 may include a base station 1302. The base station 1302 may include one or more of the features of the gNB 2000 (FIG. 20). Further, the signaling chart 1300 may include a UE 1304. The UE 1304 may include one or more of the features of the UE 1900 (FIG. 19). The UE 1304 may be connected to the base station 1302. For example, the base station 1302 may operate a cell to which the UE 1304 is connected.

The UE 1304 may have determined that a UL-sync request is to be transmitted. For example, the UE 1304 may determine that a UL-sync request is to be transmitted in accordance with any of the approaches described herein for determining that a UL-sync request is to be transmitted, such as determining that a UL out-of-sync state is approaching.

The UE 1304 may transmit a UL-sync request MAC CE 1306 to the base station 1302 based on the determination that the UE 1304 is to transmit a UL-sync request. The UE 1304 may transmit the UL-sync request MAC CE 1306 via the L2 in the illustrated embodiment. In other embodiments, the UE 1304 may transmit a UL-sync request via the L1, the L2, the L3, or some combination thereof. In the illustrated embodiment, the UE 1304 may transmit the UL-sync request MAC CE 1306 via a UE dedicated UL signal. In other embodiments, the UE 1304 may transmit the UL-sync request MAC CE 1306 via a UE dedicated UL grant. The UE 1304 may be in a UL in-sync state 1308 when the UE 1304 transmits the UL-sync request MAC CE 1306. In the illustrated embodiment, the UE 1304 may transition to a UL out-of-sync state 1310 after the UL-sync request MAC CE 1306 is transmitted.

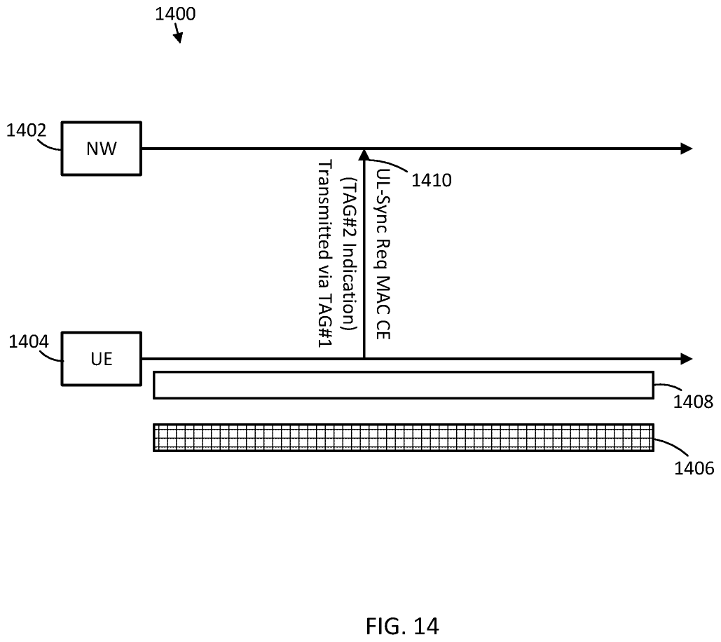

FIG. 14 illustrates an example signaling chart 1400 with UL-sync request signaling with multi-TAG configuration in accordance with some embodiments. For example, a UE may transmit a UL-sync request for a first TAG via a second TAG, the UL-sync request requesting UL synchronization for the first TAG.

The signaling chart 1400 may include a base station 1402. The base station 1402 may include one or more of the features of the gNB 2000 (FIG. 20). Further, the signaling chart 1400 may include a UE 1404. The UE 1404 may include one or more of the features of the UE 1900 (FIG. 19). The UE 1404 may be connected to the base station 1402. For example, the base station 1402 may operate a cell to which the UE 1404 is connected.

The UE 1404 may have determined that a UL-sync request is to be transmitted for a second TAG. For example, the UE 1404 may determine that a UL-sync request is to be transmitted in accordance with any of the approaches described herein for determining that a UL-sync request is to be transmitted. In the illustrated embodiment, the UE 1404 may be in a UL out-of-sync state 1406 with the second TAG. The UE 1404 may determine that a UL-sync request is to be transmitted for the second TAG based on the UE being in the UL out-of-sync state 1406 with the second TAG.

In the illustrated configuration, the UE 1404 may be prevented from transmitting the UL-sync request while the UE 1404 is in a UL out-of-sync state. Since the UE 1404 is in the UL out-of-sync state 1406 with the second TAG, the UE 1404 may be prevented from transmitting a UL-sync request via the second TAG. However, the UE 1404 may be in a UL in-sync state 1408 with the first TAG. Based on the UE 1404 being in the UL in-sync state 1408 with the first TAG.

The UE 1404 may determine that a UL-sync request is to be transmitted for the second TAG via the first TAG based on the determination that a UL-sync request is to be transmitted for the second TAG and the UE 1404 being in the UL in-sync state 1408 with the first TAG. Accordingly, the UE 1404 may transmit a UL-sync request MAC CE 1410 via the first TAG to the base station 1402. The UL-sync request MAC CE 1410 may indicate that the UL-sync request is for the second TAG. The UE 1404 may transmit the UL-sync request MAC CE 1410 via L2 signaling in the illustrated embodiment. In other embodiments, the UE 1404 may transmit a UL-sync request via L1 signaling, L2 signaling, L3 signaling, or some combination thereof. Further, the UE 1404 may transmit the UL-sync request MAC CE 1410 via a UE dedicated UL signal in the illustrated embodiment. The UE 1404 may transmit a UL-sync request via a UE dedicated UL grant in some embodiments.

The base station 1402 may identify the UL-sync request MAC CE 1410. The base station 1402 may determine that the UL-sync request MAC CE 1410 is for the second TAG. The base station 1402 may transmit information and/or trigger a procedure for synchronizing the UL for the UE 1404 for the second TAG based on the identification of the UL-sync request MAC CE 1410 and the determination that the UL-sync request MAC CE 1410 is for the second TAG.

Option 2: UE triggers RACH for UL sync purpose. For example, a UE may trigger a RACH procedure for transitioning the UE to a UL in-sync state. UE triggers the RACH when the UE is in UL out-of-sync state. The RACH configuration can be pre-configured with the dedicated resource/preamble.

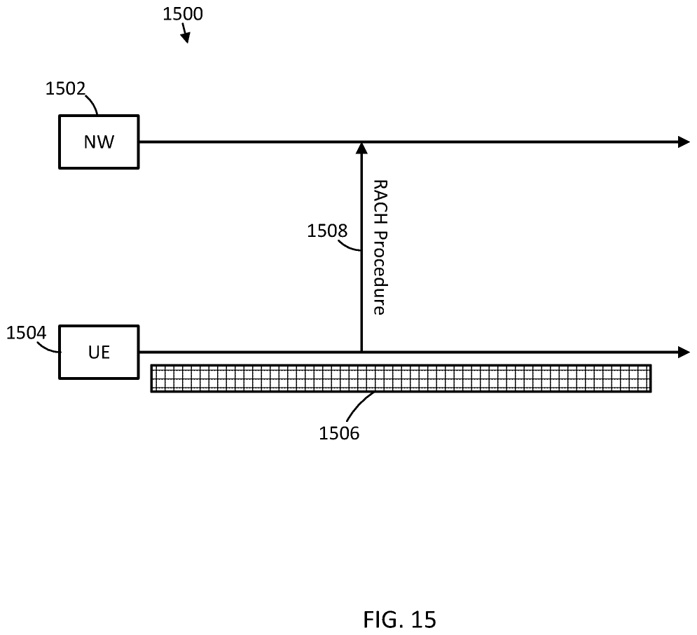

FIG. 15 illustrates an example signaling chart 1500 for RACH procedure UL-sync request in accordance with some embodiments. For example, a UE may initiate a RACH procedure as a request for synchronizing a UL of the UE. The UE may initiate the RACH procedure while the UE in in a UL out-of-sync state.

The signaling chart 1500 may include a base station 1502. The base station 1502 may include one or more of the features of the gNB 2000 (FIG. 20). Further, the signaling chart 1500 may include a UE 1504. The UE 1504 may include one or more of the features of the UE 1900 (FIG. 19). The UE 1504 may be connected to the base station 1502. For example, the base station 1502 may operate a cell to which the UE 1504 is connected.

The UE 1504 may determine that the UE 1504 is to be transitioned to a UL in-sync state. For example, the UE 1504 may be in a UL out-of-sync state 1506. The UE 1504 may determine that the UE 1504 is to be transitioned from the UL out-of-sync state 1506 to a UL in-sync state based on the UE 1504 having a UL transmission to be transmitted.

The UE 1504 may transmit a RACH procedure transmission 1508 to the base station 1502 to initiate a RACH procedure to synchronize a UL of the UE 1504. The UE 1504 may transmit the RACH procedure based on the UE 1504 being in the UL out-of-sync state 1506 and the UE 1504 having a UL transmission to be transmitted. The UE 1504 may transmit the RACH procedure transmission 1508 while the UE 1504 is in the UL out-of-sync state 1506. The RACH procedure transmission 1508 may be pre-configured with to be transmitted on a dedicated resource and/or to include a pre-configured preamble.

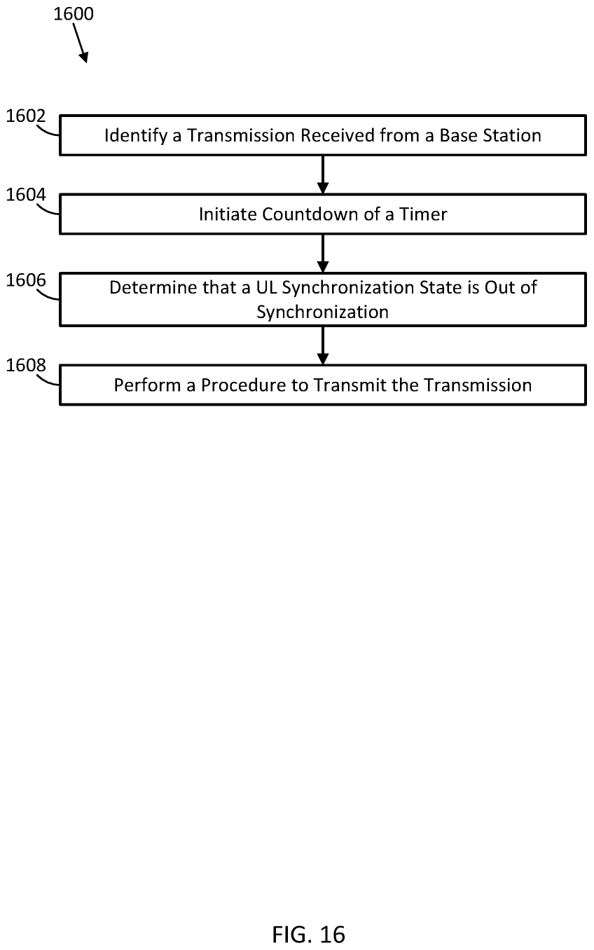

FIG. 16 illustrates an example procedure 1600 of operating a UE in accordance with some embodiments. For example, the procedure 1600 may be executed by a UE, such as the UE 104 (FIG. 1), the UE 204 (FIG. 2), the UE 304 (FIG. 3), the UE 404 (FIG. 4), the UE 504 (FIG. 5), the UE 604 (FIG. 6), the UE 704 (FIG. 7), the UE 804 (FIG. 8), the UE 904 (FIG. 9), the UE 1004 (FIG. 10), the UE 1102 (FIG. 11), the UE 1202 (FIG. 12), the UE 1304 (FIG. 13), the UE 1404 (FIG. 14), the UE 1504 (FIG. 15), and/or the UE 1900 (FIG. 19).

The procedure 1600 may include identifying a transmission received from a base station in 1602. For example, the UE may identify a transmission received from a base station. The transmission may elicit a non-preamble UL transmission from the UE. The non-preamble UL transmission may comprise UL transmission other than a preamble UL transmission, such as a PRACH or RACH preamble UL transmission. In some embodiments, the non-preamble UL transmission may comprise a PUCCH transmission, a PUSCH transmission, or an SRS.

The procedure 1600 may include initiating countdown of a timer in 1604. For example, the UE may initiate countdown of a timer at a same time that a countdown of a TAT is initiated. A countdown time of the timer may be shorter than a countdown time of the TAT. In some embodiments, 1604 may be omitted.

The procedure 1600 may include determining that a UL synchronization state is of out synchronization in 1604. For example, the UE may determine that a UL synchronization state of the UE is out of synchronization prior to the non-preamble UL transmission being transmitted by the UE.

In some embodiments, determining that the UL synchronization state is out of synchronization may include determining that the UL synchronization state is out of synchronization at a scheduled time for the non-preamble UL transmission. Further, determining that the UL synchronization state is out of synchronization may include identifying an expiration of the timer, from 1604, that occurs prior to transmission of the non-preamble UL transmission.

In some embodiments, determining that the UL synchronization state is out of synchronization may include determining a time that a TAT is to expire and determine a window including a certain amount of time prior to the expiration of the TAT in some embodiments. Further, determining that the UL synchronization state is out of synchronization may include determining that the non-preamble UL transmission has not been transmitted prior to the window in these embodiments. In some embodiments, the synchronization state determined to be out of synchronization may correspond to a first TAG.

The procedure 1600 may include performing a procedure to transmit the transmission in 1608. For example, the UE may perform a procedure to transmit the non-preamble UL transmission to the base station.

In some embodiments, performing the procedure to transmit the transmission may include transmitting a UL synchronization request to the base station. Further, the UE may identify a TAC MAC CE received from the base station. The UE may further synchronize the UE based on the TAC MAC CE to have the UL synchronization state of the UE be in synchronization in these embodiments. The UE may transmit the non-preamble UL transmission while the UL is in synchronization.

In some embodiments, performing the procedure to transmit the transmission may include transmitting the non-preamble UL transmission to the base station. Further, the UE may restart a TAT upon transmission of the non-preamble UL transmission in these embodiments, the restart of the TAT may cause the UL synchronization state of the UE to be in synchronization.

In some embodiments, performing the procedure to transmit the transmission may include restarting a TAT upon expiration of the TAT. The restart of the TAT may cause the UL synchronization state of the UE to be in synchronization. The UE may transmit the non-preamble UL transmission to the base station while the UL synchronization state of the UE is in synchronization.

In some embodiments, performing the procedure to transmit the transmission may include transmitting the non-preamble UL transmission to the base station while the UL synchronization state of the UE is out of synchronization.

In some embodiments, performing the procedure to transmit the transmission may include transmitting a UL synchronization request to the base station upon expiration of the timer from 1604. The UE may further identify a TAC MAC CE received from the base station. The UE may synchronize the UE based on the TAC MAC CE to have the UL synchronization state of the UE be in synchronization. The UE may transmit the non-preamble UL transmission while the UL synchronization is in synchronization in these embodiments.

In some embodiments, performing the procedure to transmit the transmission may include transmitting a UL synchronization request to the base station during the window from 1606. The UE may identify a TAC MAC CE received from the base station. Further, the UE may synchronize the UE based on the TAC MAC CE to have the UL synchronization state of the UE be in synchronization. The UE may transmit the non-preamble UL transmission while the UL synchronization state is in synchronization in these embodiments.

In some embodiments, performing the procedure to transmit the transmission may include transmitting a UL synchronization request via L1, L2, or L3 signaling to the base station. The UE may identify a TAC MAC CE received from the base station. Further, the UE may synchronize the UE based on the TAC MAC CE to have the UL synchronization state of the UE be in synchronization. The UE may transmit the non-preamble UL transmission while the UL synchronization state is in synchronization in these embodiments. In some of these embodiments where the synchronization state corresponds to a first TAG, the UL synchronization request may be transmitted via a second TAG.

In some embodiments, performing the procedure to transmit the transmission may include triggers a RACH procedure for UL synchronization. The UE may synchronize the UE based on the RACH procedure. Further, the UE may transmit the non-preamble UL transmission while the UL synchronization state is in synchronization in these embodiments.

While FIG. 16 may imply an order of the procedure 1600, it should be understood that the order may be different in other embodiments and/or one or more of the operations may be performed concurrently in other embodiments. Further, it should be understood that one or more of the operations may be omitted from and/or one or more additional operations may be included in the procedure 1600 in other embodiments.

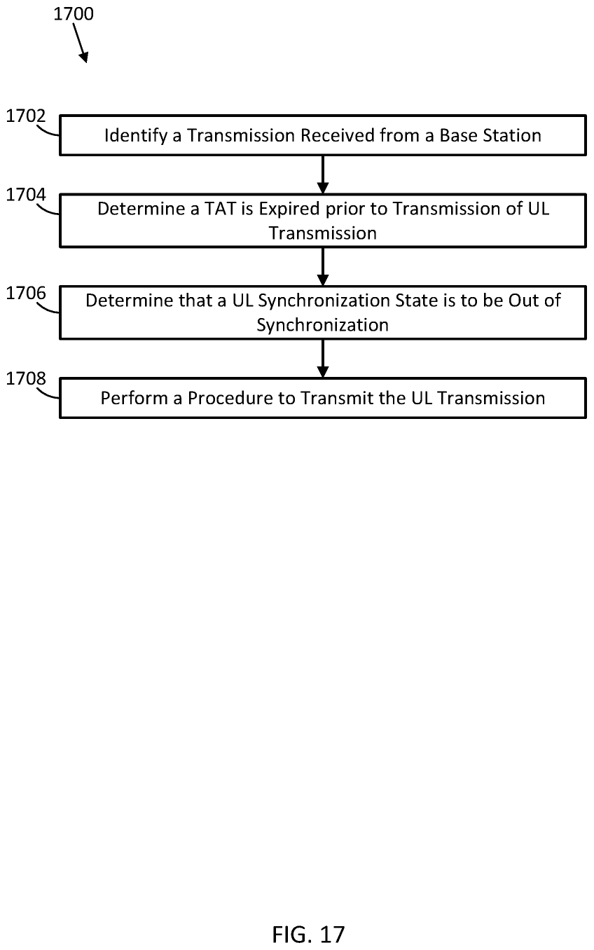

FIG. 17 illustrates an example procedure 1700 of operating a UE in accordance with some embodiments. For example, the procedure 1700 may be executed by a UE, such as the UE 104 (FIG. 1), the UE 204 (FIG. 2), the UE 304 (FIG. 3), the UE 404 (FIG. 4), the UE 504 (FIG. 5), the UE 604 (FIG. 6), the UE 704 (FIG. 7), the UE 804 (FIG. 8), the UE 904 (FIG. 9), the UE 1004 (FIG. 10), the UE 1102 (FIG. 11), the UE 1202 (FIG. 12), the UE 1304 (FIG. 13), the UE 1404 (FIG. 14), the UE 1504 (FIG. 15), and/or the UE 1900 (FIG. 19).

The procedure 1700 may include identifying a transmission received from a base station in 1702. For example, the UE may identify a transmission received from a base station. The transmission may elicit a UL transmission from the UE.

In some embodiments, the UL transmission may include a PUCCH transmission, a PUSCH transmission, or an SRS.

In some embodiments, the transmission received from base station may include a PDSCH transmission. In these embodiments, the UL transmission may include an A/N feedback transmission.

In some embodiments, the transmission received from the base station may include a UL grant. In these embodiments, the UL transmission may include a PUSCH transmission.

The procedure 1700 may include determining a TAT is expired prior to transmission of the UL transmission in 1704. For example, the UE may determine that a TAT is expired prior to transmission of the UL transmission.

The procedure 1700 may include determining that a UL synchronization state is to be out of synchronization in 1706. For example, the UE may determine that a UL synchronization state of the UE is to be out of synchronization based on the TAT being expired. In some embodiments, determining that the UL synchronization state is to be out of synchronization my include determining that the UL synchronization state is out of synchronization at a scheduled time for the UL transmission.

The procedure 1700 may include performing a procedure to transmit the UL transmission in 1708. For example, the UE may perform a procedure to transmit the UL transmission to the base station.

In some embodiments, performing the procedure to transmit the UL transmission may include transmitting a UL synchronization request to the base station while the UL synchronization state is out of synchronization. The UE may identify a TAC MAC CE received from the base station. Further, the UE may synchronize the UE based on the TAC MAC CE to have the UL synchronization state of the UE be in synchronization. In these embodiments, the UE may transmit the UL transmission while the UL synchronization state is in synchronization.

In some embodiments, performing the procedure may include transmitting the UL transmission to the base station. Further, the UE may restart the TAT upon transmission of the UL transmission to cause the UL synchronization state of the UE to be in synchronization in these embodiments.

In some embodiments, performing the procedure may include restarting the TAT upon expiration of the TAT. The restart of the TAT may cause the UL synchronization state of the UE to be in synchronization. The UE may transmit the UL transmission to the base station while the UL synchronization state of the UE is in synchronization.

While FIG. 17 may imply an order of the procedure 1700, it should be understood that the order may be different in other embodiments and/or one or more of the operations may be performed concurrently in other embodiments. Further, it should be understood that one or more of the operations may be omitted from and/or one or more additional operations may be included in the procedure 1700 in other embodiments.

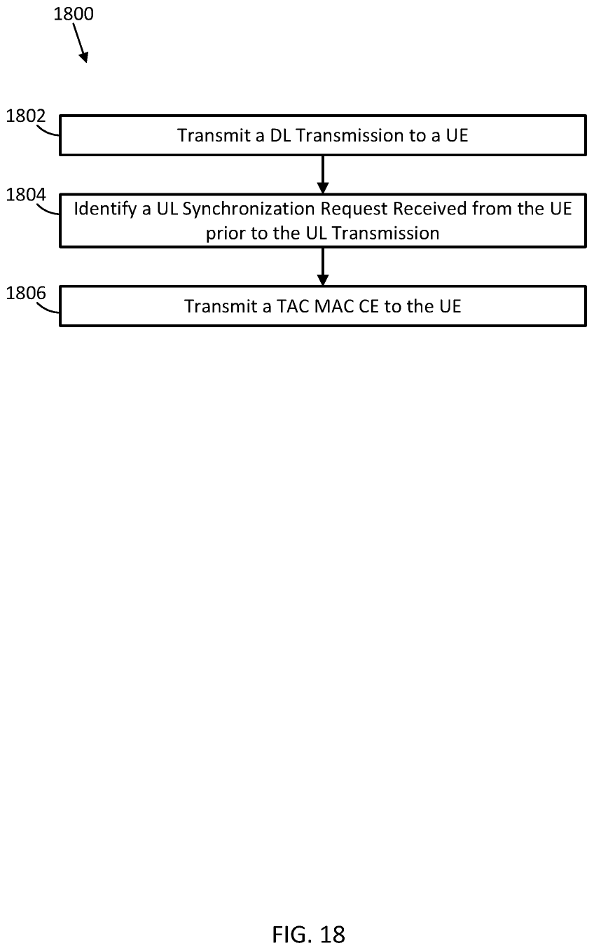

FIG. 18 illustrates an example procedure 1800 of operating a base station in accordance with some embodiments. For example, the procedure 1800 may be executed by a base station, such as the base station 102 (FIG. 1), the base station 202 (FIG. 2), the base station 302 (FIG. 3), the base station 402 (FIG. 4), the base station 502 (FIG. 5), the base station 602 (FIG. 6), the base station 702 (FIG. 7), the base station 802 (FIG. 8), the base station 902 (FIG. 9), the base station 1002 (FIG. 10), the base station 1302 (FIG. 13), the base station 1402 (FIG. 14), the base station 1502 (FIG. 15), and/or the gNB 2000 (FIG. 20).

The procedure 1800 may include transmitting a DL transmission to a UE in 1802. For example, the base station may transmit a DL transmission to a UE. The DL transmission may elicit a UL transmission from the UE.

The procedure 1800 may include identifying a UL synchronization request received from the UE prior to the UL transmission in 1804. For example, the base station may identify a UL synchronization request received from the UE prior to the UL transmission elicited by the DL transmission. In some embodiments, the UL synchronization request may be received from the UE via L1, L2, or L3 signaling.

The procedure 1800 may include transmitting a TAC MAC CE to the UE in 1806. For example, the base station may transmit a TAC MAC CE to the UE. The TAC MAC CE may be utilized by the UE for synchronization of a UL synchronization state of the UE. In some embodiments, the TAC MAC CE may include a value for a TAT maintained by the UE.

While FIG. 18 may imply an order of the procedure 1800, it should be understood that the order may be different in other embodiments and/or one or more of the operations may be performed concurrently in other embodiments. Further, it should be understood that one or more of the operations may be omitted from and/or one or more additional operations may be included in the procedure 1800 in other embodiments.

FIG. 19 illustrates an example UE 1900 in accordance with some embodiments. The UE 1900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1900 may be a RedCap UE or NR-Light UE.

The UE 1900 may include processors 1904, RF interface circuitry 1908, memory/storage 1912, user interface 1916, sensors 1920, driver circuitry 1922, power management integrated circuit (PMIC) 1924, antenna structure 1926, and battery 1928. The components of the UE 1900 may be implemented as integrated circuits (ICs), portions thereof, discrete electronic devices, or other modules, logic, hardware, software, firmware, or a combination thereof. The block diagram of FIG. 19 is intended to show a high-level view of some of the components of the UE 1900. However, some of the components shown may be omitted, additional components may be present, and different arrangement of the components shown may occur in other implementations.

The components of the UE 1900 may be coupled with various other components over one or more interconnects 1932, which may represent any type of interface, input/output, bus (local, system, or expansion), transmission line, trace, optical connection, etc. that allows various circuit components (on common or different chips or chipsets) to interact with one another.

The processors 1904 may include processor circuitry such as, for example, baseband processor circuitry (BB) 1904A, central processor unit circuitry (CPU) 1904B, and graphics processor unit circuitry (GPU) 1904C. The processors 1904 may include any type of circuitry or processor circuitry that executes or otherwise operates computer-executable instructions, such as program code, software modules, or functional processes from memory/storage 1912 to cause the UE 1900 to perform operations as described herein.

In some embodiments, the baseband processor circuitry 1904A may access a communication protocol stack 1936 in the memory/storage 1912 to communicate over a 3GPP compatible network. In general, the baseband processor circuitry 1904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1908.

The baseband processor circuitry 1904A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1912 may include one or more non-transitory, computer-readable media that includes instructions (for example, communication protocol stack 1936) that may be executed by one or more of the processors 1904 to cause the UE 1900 to perform various operations described herein. The memory/storage 1912 include any type of volatile or non-volatile memory that may be distributed throughout the UE 1900. In some embodiments, some of the memory/storage 1912 may be located on the processors 1904 themselves (for example, L1 and L2 cache), while other memory/storage 1912 is external to the processors 1904 but accessible thereto via a memory interface. The memory/storage 1912 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1908 may include transceiver circuitry and radio frequency front module (RFEM) that allows the UE 1900 to communicate with other devices over a radio access network. The RF interface circuitry 1908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1926 and proceed to filter and amplify (with a low-noise amplifier) the signal. The signal may be provided to a receiver of the transceiver that down-converts the RF signal into a baseband signal that is provided to the baseband processor of the processors 1904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1926.

In various embodiments, the RF interface circuitry 1908 may be configured to transmit/receive signals in a manner compatible with NR access technologies.

The antenna 1926 may include antenna elements to convert electrical signals into radio waves to travel through the air and to convert received radio waves into electrical signals. The antenna elements may be arranged into one or more antenna panels. The antenna 1926 may have antenna panels that are omnidirectional, directional, or a combination thereof to enable beamforming and multiple input, multiple output communications. The antenna 1926 may include microstrip antennas, printed antennas fabricated on the surface of one or more printed circuit boards, patch antennas, phased array antennas, etc. The antenna 1926 may have one or more panels designed for specific frequency bands including bands in FR1 or FR2.

The user interface circuitry 1916 includes various input/output (I/O) devices designed to enable user interaction with the UE 1900. The user interface 1916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1900.

The sensors 1920 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1922 may include software and hardware elements that operate to control particular devices that are embedded in the UE 1900, attached to the UE 1900, or otherwise communicatively coupled with the UE 1900. The driver circuitry 1922 may include individual drivers allowing other components to interact with or control various input/output (I/O) devices that may be present within, or connected to, the UE 1900. For example, driver circuitry 1922 may include a display driver to control and allow access to a display device, a touchscreen driver to control and allow access to a touchscreen interface, sensor drivers to obtain sensor readings of sensor circuitry 1920 and control and allow access to sensor circuitry 1920, drivers to obtain actuator positions of electro-mechanic components or control and allow access to the electro-mechanic components, a camera driver to control and allow access to an embedded image capture device, audio drivers to control and allow access to one or more audio devices.

The PMIC 1924 may manage power provided to various components of the UE 1900. In particular, with respect to the processors 1904, the PMIC 1924 may control power-source selection, voltage scaling, battery charging, or DC-to-DC conversion.

In some embodiments, the PMIC 1924 may control, or otherwise be part of, various power saving mechanisms of the UE 1900. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1900 may power down for brief intervals of time and thus save power. If there is no data traffic activity for an extended period of time, then the UE 1900 may transition off to an RRC Idle state, where it disconnects from the network and does not perform operations such as channel quality feedback, handover, etc. The UE 1900 goes into a very low power state and it performs paging where again it periodically wakes up to listen to the network and then powers down again. The UE 1900 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1928 may power the UE 1900, although in some examples the UE 1900 may be mounted deployed in a fixed location, and may have a power supply coupled to an electrical grid. The battery 1928 may be a lithium ion battery, a metal-air battery, such as a zinc-air battery, an aluminum-air battery, a lithium-air battery, and the like. In some implementations, such as in vehicle-based applications, the battery 1928 may be a typical lead-acid automotive battery.

FIG. 20 illustrates an example gNB 2000 in accordance with some embodiments. The gNB 2000 may include processors 2004, RF interface circuitry 2008, core network (CN) interface circuitry 2012, memory/storage circuitry 2016, and antenna structure 2026.

The components of the gNB 2000 may be coupled with various other components over one or more interconnects 2028.

The processors 2004, RF interface circuitry 2008, memory/storage circuitry 2016 (including communication protocol stack 2010), antenna structure 2026, and interconnects 2028 may be similar to like-named elements shown and described with respect to FIG. 19.

The CN interface circuitry 2012 may provide connectivity to a core network, for example, a 5th Generation Core network (5GC) using a 5GC-compatible network interface protocol such as carrier Ethernet protocols, or some other suitable protocol. Network connectivity may be provided to/from the gNB 2000 via a fiber optic or wireless backhaul. The CN interface circuitry 2012 may include one or more dedicated processors or FPGAs to communicate using one or more of the aforementioned protocols. In some implementations, the CN interface circuitry 2012 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising identifying a transmission received from a base station, the transmission to elicit a non-preamble UL transmission from the UE, determining that an uplink (UL) synchronization state of the UE is out of synchronization prior to the non-preamble UL transmission being transmitted by the UE, and performing a procedure to transmit the non-preamble UL transmission to the base station.

Example 2 may include the method of example 1, wherein the non-preamble UL transmission comprises a physical uplink control channel (PUCCH) transmission, a physical uplink shared channel (PUSCH) transmission, or a sounding reference signal (SRS).

Example 3 may include the method of example 1, wherein determining that the UL synchronization state is out of synchronization comprises determining that the UL synchronization state is out of synchronization at a scheduled time for the non-preamble UL transmission, and wherein performing the procedure comprises transmitting a UL synchronization request to the base station, identifying a timing advance command (TAC) medium access control (MAC) control element (CE) received from the base station, synchronizing the UE based on the TAC MAC CE to have the UL synchronization state of the UE be in synchronization, and transmitting the non-preamble UL transmission while the UL synchronization state is in synchronization.

Example 4 may include the method of example 1, wherein performing the procedure comprises transmitting the non-preamble UL transmission to the base station, and restarting a timing alignment timer (TAT) upon the transmission of the non-preamble UL transmission, the restart of the TAT to cause the UL synchronization state of the UE to be in synchronization.

Example 5 may include the method of example 1, wherein performing the procedure comprises restarting a timing alignment timer (TAT) upon expiration of the TAT, the restart of the TAT to cause the UL synchronization state of the UE to be in synchronization, and transmitting the non-preamble UL transmission to the base station while the UL synchronization state of the UE is in synchronization.

Example 6 may include the method of example 1, wherein performing the procedure comprises transmitting the non-preamble UL transmission to the base station while the UL synchronization state of the UE is out of synchronization.

Example 7 may include the method of example 1, further comprising initiating countdown of a timer at a same time that a countdown of a timing alignment timer (TAT) is initiated, a countdown time of the timer being shorter than a countdown time of the TAT, wherein determining that the UL is out of synchronization comprises identifying an expiration of the timer that occurs prior to transmission of the non-preamble UL transmission, and wherein to perform the procedure comprises transmitting a UL synchronization request to the base station upon the expiration of the timer, identifying a timing advance command (TAC) medium access control (MAC) control element (CE) received from the base station, synchronizing the UE based on the TAC MAC CE to have the UL synchronization state of the UE be in synchronization, and transmitting the non-preamble UL transmission while the UL synchronization state is in synchronization.

Example 8 may include the method of example 1, wherein determining that the UL synchronization state is out of synchronization comprises determining a time that a timing alignment timer (TAT) is to expire, determining a window including a certain amount of time prior to the expiration of the TAT, and determining that the non-preamble UL transmission has not been transmitted prior to the window, and performing the procedure comprises transmitting a UL synchronization request to the base station during the window, identifying a timing advance command (TAC) medium access control (MAC) control element (CE) received from the base station, synchronizing the UE based on the TAC MAC CE to have the UL synchronization state of the UE be in synchronization, and transmitting the non-preamble UL transmission while the UL synchronization state is in synchronization.

Example 9 may include the one or more computer-readable media of example 1, wherein to perform the procedure comprises transmitting a UL synchronization request via layer 1 (L1), layer 2 (L2), or layer 3 (L3) signaling to the base station identifying a timing advance command (TAC) medium access control (MAC) control element (CE) received from the base station, synchronizing the UE based on the TAC MAC CE to have the UL synchronization state of the UE be in synchronization, and transmitting the non-preamble UL transmission while the UL synchronization state is in synchronization.

Example 10 may include the one or more computer-readable media of example 9, wherein the synchronization state that is determined to be out of synchronization corresponds to a first timing advance group (TAG), and wherein transmitting the UL synchronization request comprises transmitting the UL synchronization request via a second TAG.

Example 11 may include the one or more computer-readable media of example 1, wherein to perform the procedure comprises triggering a random access channel (RACH) procedure for UL synchronization, synchronizing the UE based on the RACH procedure, and transmitting the non-preamble UL transmission while the UL synchronization state is in synchronization.

Example 12 may include a method of operating a user equipment (UE), comprising identifying a transmission received from a base station, the transmission to elicit an uplink (UL) transmission from the UE, determining that a timing alignment timer (TAT) is expired prior to transmission of the UL transmission, determining that a UL synchronization state of the UE is to be out of synchronization based on the TAT being expired, and performing a procedure to transmit the UL transmission to the base station.

Example 13 may include the method of example 12, wherein the UL transmission comprises a physical uplink control channel (PUCCH) transmission, a physical uplink shared channel (PUSCH), or a sounding reference signal (SRS).

Example 14 may include the method of example 12, wherein the transmission received from the base station comprises a physical downlink shared channel (PDSCH) transmission, and wherein the UL transmission comprises an acknowledgement/negative acknowledgement (A/N) feedback transmission.

Example 15 may include the method of example 12, wherein the transmission received from the base station comprises a UL grant, and wherein the UL transmission comprises a physical uplink shared channel (PUSCH) transmission.

Example 16 may include the method of example 12, wherein determining that the UL synchronization state is to be out of synchronization comprises determining that the UL synchronization state is out of synchronization at a scheduled time for the UL transmission, and wherein performing the procedure comprises transmitting a UL synchronization request to the base station while the UL synchronization state is out of synchronization, identifying a timing advance command (TAC) medium access control (MAC) control element (CE) received from the base station, synchronizing the UE based on the TAC MAC CE to have the UL synchronization state of the UE be in synchronization, and transmitting the UL transmission while the UL synchronization state is in synchronization.

Example 17 may include the method of example 12, wherein performing the procedure comprises transmitting the UL transmission to the base station, and restarting the TAT upon the transmission of the UL transmission to cause the UL synchronization state of the UE to be in synchronization.

Example 18 may include the method of example 12, wherein performing the procedure comprises restarting the TAT upon expiration of the TAT, the restart of the TAT to cause the UL synchronization state of the UE to be in synchronization, and transmitting the UL transmission to the base station while the UL synchronization state of the UE is in synchronization.

Example 19 may include a method of operating a base station, comprising transmitting a downlink (DL) transmission to a user equipment (UE), the DL transmission to elicit an uplink (UL) transmission from the UE, identifying a UL synchronization request received from the UE prior to the UL transmission elicited by the DL transmission, and transmit a timing advance command (TAC) medium access control (MAC) control element (CE) to the UE, the TAC MAC CE to be utilized by the UE for synchronization of a UL synchronization state of the UE.

Example 20 may include the method of example 19, wherein the TAC MAC CE comprises a value for a timing alignment timer (TAT) maintained by the UE.

Example 21 may include the method of example 19, wherein the UL synchronization request is received from the UE via layer 1 (L1), layer 2 (L2), or layer 3 (L3) signaling.

Example 22 may include a method of executing a UE, comprising identifying a transmission received from a base station, the transmission to elicit a physical uplink control channel (PUCCH) transmission, a physical uplink shared channel (PUSCH) transmission, or a sounding reference signal (SRS) from the UE, determining that an uplink (UL) synchronization state of the UE is out of synchronization prior to the PUCCH transmission, the PUSCH transmission, or the SRS being transmitted by the UE, and performing a procedure to transmit the PUCCH transmission, the PUSCH transmission, or the SRS to the base station.

Example 23 may include the method of example 22, wherein determining that the UL synchronization state is out of synchronization comprises determining that the UL synchronization state is out of synchronization at a scheduled time for the PUCCH transmission, the PUSCH transmission, or the SRS, and wherein performing the procedure comprises transmitting a UL synchronization request to the base station, identifying a timing advance command (TAC) medium access control (MAC) control element (CE) received from the base station, synchronizing the UE based on the TAC MAC CE to have the UL synchronization state of the UE be in synchronization, and transmitting the PUCCH transmission, the PUSCH transmission, or the SRS while the UL synchronization state is in synchronization.

Example 24 may include the method of example 22, wherein performing the procedure comprises transmitting the PUCCH transmission, the PUSCH transmission, or the SRS to the base station, and restarting a timing alignment timer (TAT) upon the transmission of the PUCCH transmission, the PUSCH transmission, or the SRS, the restart of the TAT to cause the UL synchronization state of the UE to be in synchronization.

Example 25 may include the method of example 22, wherein performing the procedure comprises restarting a timing alignment timer (TAT) upon expiration of the TAT, the restart of the TAT to cause the UL synchronization state of the UE to be in synchronization, and transmitting the PUCCH transmission, the PUSCH transmission, or the SRS to the base station while the UL synchronization state of the UE is in synchronization.

Example 26 may include the method of example 22, wherein performing the procedure comprises transmitting the PUCCH transmission, the PUSCH transmission, or the SRS to the base station while the UL synchronization state of the UE is out of synchronization.

Example 27 may include the method of example 22, further comprising initiating countdown of a timer at a same time that a countdown of a timing alignment timer (TAT) is initiated, a countdown time of the timer being shorter than a countdown time of the TAT, wherein determining that the UL is out of synchronization comprises identifying an expiration of the timer that occurs prior to transmission of the PUCCH transmission, the PUSCH transmission, or the SRS, and wherein performing the procedure comprises transmitting a UL synchronization request to the base station upon the expiration of the timer, identifying a timing advance command (TAC) medium access control (MAC) control element (CE) received from the base station, synchronizing the UE based on the TAC MAC CE to have the UL synchronization state of the UE be in synchronization, and transmitting the PUCCH transmission, the PUSCH transmission, or the SRS while the UL synchronization state is in synchronization.

Example 28 may include the method of example 22, wherein determining that the UL synchronization state is out of synchronization comprises determining a time that a timing alignment timer (TAT) is to expire, determining a window including a certain amount of time prior to the expiration of the TAT, and determining that the PUCCH transmission, the PUSCH transmission, or the SRS has not been transmitted prior to the window, and performing the procedure comprises transmitting a UL synchronization request to the base station during the window, identifying a timing advance command (TAC) medium access control (MAC) control element (CE) received from the base station, synchronizing the UE based on the TAC MAC CE to have the UL synchronization state of the UE be in synchronization, and transmitting the PUCCH transmission, the PUSCH transmission, or the SRS while the UL synchronization state is in synchronization.

Example 29 may include the method of example 22, wherein performing the procedure comprises transmitting a UL synchronization request via layer 1 (L1), layer 2 (L2), or layer 3 (L3) signaling to the base station, identifying a timing advance command (TAC) medium access control (MAC) control element (CE) received from the base station, synchronizing the UE based on the TAC MAC CE to have the UL synchronization state of the UE be in synchronization, and transmitting the PUCCH transmission, the PUSCH transmission, or the SRS while the UL synchronization state is in synchronization.

Example 30 may include the method of example 29, wherein the synchronization state that is determined to be out of synchronization corresponds to a first timing advance group (TAG), and wherein transmitting the UL synchronization request comprises transmitting the UL synchronization request via a second TAG.

Example 31 may include the method of example 22, wherein performing the procedure comprises triggering a random access channel (RACH) procedure for UL synchronization, synchronizing the UE based on the RACH procedure, and transmitting the PUCCH transmission, the PUSCH transmission, or the SRS while the UL synchronization state is in synchronization.

Example 32 may include an apparatus comprising means to perform one or more elements of a method described in or related to any of examples 1-31, or any other method or process described herein.

Example 33 may include one or more non-transitory computer-readable media comprising instructions to cause an electronic device, upon execution of the instructions by one or more processors of the electronic device, to perform one or more elements of a method described in or related to any of examples 1-31, or any other method or process described herein.

Example 34 may include an apparatus comprising logic, modules, or circuitry to perform one or more elements of a method described in or related to any of examples 1-31, or any other method or process described herein.

Example 35 may include a method, technique, or process as described in or related to any of examples 1-31, or portions or parts thereof.

Example 36 may include an apparatus comprising: one or more processors and one or more computer-readable media comprising instructions that, when executed by the one or more processors, cause the one or more processors to perform the method, techniques, or process as described in or related to any of examples 1-31, or portions thereof.

Example 37 may include a signal as described in or related to any of examples 1-31, or portions or parts thereof.

Example 38 may include a datagram, information element, packet, frame, segment, PDU, or message as described in or related to any of examples 1-31, or portions or parts thereof, or otherwise described in the present disclosure.

Example 39 may include a signal encoded with data as described in or related to any of examples 1-31, or portions or parts thereof, or otherwise described in the present disclosure.

Example 40 may include a signal encoded with a datagram, IE, packet, frame, segment, PDU, or message as described in or related to any of examples 1-31, or portions or parts thereof, or otherwise described in the present disclosure.

Example 41 may include an electromagnetic signal carrying computer-readable instructions, wherein execution of the computer-readable instructions by one or more processors is to cause the one or more processors to perform the method, techniques, or process as described in or related to any of examples 1-31, or portions thereof.

Example 42 may include a computer program comprising instructions, wherein execution of the program by a processing element is to cause the processing element to carry out the method, techniques, or process as described in or related to any of examples 1-31, or portions thereof.

Example 43 may include a signal in a wireless network as shown and described herein.

Example 44 may include a method of communicating in a wireless network as shown and described herein.

Example 45 may include a system for providing wireless communication as shown and described herein.

Example 46 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory computer-readable media having instructions that, when executed by one or more processors, cause a user equipment (UE) to:
identify a transmission received from a base station, the transmission to elicit a non-preamble uplink (UL) transmission from the UE;
determine that a UL synchronization state of the UE is out of synchronization prior to the non-preamble UL transmission being transmitted by the UE; and
perform a procedure to transmit the non-preamble UL transmission to the base station.

2. The one or more non-transitory computer-readable media of claim 1, wherein the non-preamble UL transmission comprises a physical uplink control channel (PUCCH) transmission, a physical uplink shared channel (PUSCH) transmission, or a sounding reference signal (SRS).

3. The one or more non-transitory computer-readable media of claim 1, wherein to determine that the UL synchronization state is out of synchronization comprises to determine that the UL synchronization state is out of synchronization at a scheduled time for the non-preamble UL transmission, and wherein to perform the procedure comprises to:
transmit a UL synchronization request to the base station;
identify a timing advance command (TAC) medium access control (MAC) control element (CE) received from the base station;
synchronize the UE based on the TAC MAC CE to have the UL synchronization state of the UE be in synchronization; and
transmit the non-preamble UL transmission while the UL synchronization state is in synchronization.

4. The one or more non-transitory computer-readable media of claim 1, wherein to perform the procedure comprises to:
transmit the non-preamble UL transmission to the base station; and
restart a timing alignment timer (TAT) upon the transmission of the non-preamble UL transmission, the restart of the TAT to cause the UL synchronization state of the UE to be in synchronization.

5. The one or more non-transitory computer-readable media of claim 1, wherein to perform the procedure comprises to:
restart a timing alignment timer (TAT) upon expiration of the TAT, the restart of the TAT to cause the UL synchronization state of the UE to be in synchronization; and
transmit the non-preamble UL transmission to the base station while the UL synchronization state of the UE is in synchronization.

6. The one or more non-transitory computer-readable media of claim 1, wherein to perform the procedure comprises to transmit the non-preamble UL transmission to the base station while the UL synchronization state of the UE is out of synchronization.

7. The one or more non-transitory computer-readable media of claim 1, wherein the instructions, when executed by the one or more processors, further cause the UE to:
initiate countdown of a timer at a same time that a countdown of a timing alignment timer (TAT) is initiated, a countdown time of the timer being shorter than a countdown time of the TAT, wherein to determine that the UL is out of synchronization comprises to identify an expiration of the timer that occurs prior to transmission of the non-preamble UL transmission, and wherein to perform the procedure comprises to:
transmit a UL synchronization request to the base station upon the expiration of the timer;
identify a timing advance command (TAC) medium access control (MAC) control element (CE) received from the base station;
synchronize the UE based on the TAC MAC CE to have the UL synchronization state of the UE be in synchronization; and
transmit the non-preamble UL transmission while the UL synchronization state is in synchronization.

8. The one or more non-transitory computer-readable media of claim 1, wherein:
to determine that the UL synchronization state is out of synchronization comprises to:
determine a time that a timing alignment timer (TAT) is to expire;
determine a window including a certain amount of time prior to the expiration of the TAT; and
determine that the non-preamble UL transmission has not been transmitted prior to the window; and
to perform the procedure comprises to:
transmit a UL synchronization request to the base station during the window;
identify a timing advance command (TAC) medium access control (MAC) control element (CE) received from the base station;
synchronize the UE based on the TAC MAC CE to have the UL synchronization state of the UE be in synchronization; and
transmit the non-preamble UL transmission while the UL synchronization state is in synchronization.

9. The one or more non-transitory computer-readable media of claim 1, wherein to perform the procedure comprises to:
transmit a UL synchronization request via layer 1 (L1), layer 2 (L2), or layer 3 (L3) signaling to the base station;
identify a timing advance command (TAC) medium access control (MAC) control element (CE) received from the base station;
synchronize the UE based on the TAC MAC CE to have the UL synchronization state of the UE be in synchronization; and
transmit the non-preamble UL transmission while the UL synchronization state is in synchronization.

10. The one or more non-transitory computer-readable media of claim 9, wherein the synchronization state that is determined to be out of synchronization corresponds to a first timing advance group (TAG), and wherein to transmit the UL synchronization request comprises to transmit the UL synchronization request via a second TAG.

11. The one or more non-transitory computer-readable media of claim 1, wherein to perform the procedure comprises to:
trigger a random access channel (RACH) procedure for UL synchronization;
synchronize the UE based on the RACH procedure; and
transmit the non-preamble UL transmission while the UL synchronization state is in synchronization.

12. A user equipment (UE), comprising:
memory to store transmissions exchanged with the UE; and
one or more processors coupled to memory, the one or more processors to:
identify a transmission received from a base station, the transmission to elicit an uplink (UL) transmission from the UE;
determine that a timing alignment timer (TAT) is expired prior to transmission of the UL transmission;
determine that a UL synchronization state of the UE is to be out of synchronization based on the TAT being expired; and
perform a procedure to transmit the UL transmission to the base station.

13. The UE of claim 12, wherein the UL transmission comprises a physical uplink control channel (PUCCH) transmission, a physical uplink shared channel (PUSCH), or a sounding reference signal (SRS).

14. The UE of claim 12, wherein the transmission received from the base station comprises a physical downlink shared channel (PDSCH) transmission, and wherein the UL transmission comprises an acknowledgement/negative acknowledgement (A/N) feedback transmission.

15. The UE of claim 12, wherein the transmission received from the base station comprises a UL grant, and wherein the UL transmission comprises a physical uplink shared channel (PUSCH) transmission.

16. The UE of claim 12, wherein to determine that the UL synchronization state is to be out of synchronization comprises to determine that the UL synchronization state is out of synchronization at a scheduled time for the UL transmission, and wherein to perform the procedure comprises to:
transmit a UL synchronization request to the base station while the UL synchronization state is out of synchronization;
identify a timing advance command (TAC) medium access control (MAC) control element (CE) received from the base station;
synchronize the UE based on the TAC MAC CE to have the UL synchronization state of the UE be in synchronization; and
transmit the UL transmission while the UL synchronization state is in synchronization.

17. The UE of claim 12, wherein to perform the procedure comprises to:
transmit the UL transmission to the base station; and
restart the TAT upon the transmission of the UL transmission to cause the UL synchronization state of the UE to be in synchronization.

18. A method of operating a base station, comprising:
transmitting a downlink (DL) transmission to a user equipment (UE), the DL transmission to elicit an uplink (UL) transmission from the UE;
identifying a UL synchronization request received from the UE prior to the UL transmission elicited by the DL transmission; and
transmit a timing advance command (TAC) medium access control (MAC) control element (CE) to the UE, the TAC MAC CE to be utilized by the UE for synchronization of a UL synchronization state of the UE.

19. The method of claim 18, wherein the TAC MAC CE comprises a value for a timing alignment timer (TAT) maintained by the UE.

20. The method of claim 18, wherein the UL synchronization request is received from the UE via layer 1 (L1), layer 2 (L2), or layer 3 (L3) signaling.
